(19) United States
(12) Patent Application Publication
(10) Pub. No.: US 2008/0040690 A1
(43) Pub. Date: Feb. 14, 2008

(54) Directory Management Program, Object Display Program, Directory Management Method, And Directory Management Apparatus

(75) Inventor: Hiroaki Sakai, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 11/870,517

(22) Filed: Oct. 11, 2007

Related U.S. Application Data
(62) Division of application No. 10/612,568, filed on Jul. 2, 2003.
(60) Provisional application No. 60/396,430, filed on Jul. 15, 2002.

(30) Foreign Application Priority Data
Apr. 9, 2003 (JP) 2003105629
Apr. 9, 2003 (JP) 2003-105629

(51) Int. Cl. G09G 5/00

(52) U.S. Cl. 715/853

(57) ABSTRACT

A directory management program, an object display program, a directory management method, and a directory management apparatus organize and catalogue information using a time line as an important factor by imparting a concept of temporal width to the current concept of folders and arranging objects inside a folder along the time line. A computer sets a directory management parameter and a time line parameter for each specific object in the directory. Based on the values of the directory management parameter and time line parameter for a given object, the object is linked to and displayed in a particular cell of a directory matrix defined by the directory management parameter and time line parameter.

### CROSS-REFERENCE TO RELATED APPLICATIONS

This application is a divisional of U.S. patent application Ser. No. 10/612,568 filed Jul. 2, 2003, and claims the benefit of the provisional application Ser. No. 60/396,430, filed Jul. 15, 2002.

### BACKGROUND

1. Field of Invention

The present invention relates to a directory management program, an object display program, a directory management method, and a directory management apparatus providing an intuitive user interface for managing directories in a computer system.

2. Description of the Related Art

While computers have made document creation much easier, particularly documents containing image information and video information, computer networks have made it possible to store information created or acquired by individual users in a single database kept on a network server for sharing with other users that are involved in the same task, for example, or need access to that information. Such information sharing promotes greater efficiency and job productivity while facilitating dissemination of knowledge and information.

This information can be visually catalogued to a certain extent using an operating system having a graphical user interface (GUI) such as Microsoft Windows (R). A unique icon is assigned to each document (file) according to the software used to create the document, and this icon makes it easy to know the file type of a particular document, that is, what software program was used to create the document.

Giving an appropriate title (name) to each file also makes it possible to know the content of a file without actually opening the file.

The concept of folders has been used for organizing and cataloguing files, and by creating folders in a hierarchical structure the information can be hierarchically organized according to purpose or content.

Japanese Patent Laid-Open Publication (kokai) 2002-259898, for example, teaches a directory management method and technology whereby the latest version of documents of a type appropriate to the project type are batch selected and created, and the project name and manager are automatically input. More particularly, form documents and settings for those forms are created and saved, and basic information about a specific project proposal is input and saved. A template to be used is then selected from plural available templates based on this basic information, and the form document to be used for the project proposal is extracted based on the selected template. The extracted form document is then updated based on the basic information for the project proposal and stored in a project folder of project documents.

The folder-based method described above for stratifying and managing information related to a specific task is certainly an effective way of organizing information related to actual projects in a corporate environment. The current system of folders and hierarchical directory structures is, however, incapable of efficiently organizing and displaying on a time line information relating to projects that continue for an extended period of time.

It is, of course, possible to create subfolders such as “orientation,” “information gathering,” “design,” and “production” inside a “Project A” folder, and create subfolders such as “January 2002” and “February 2002” in the “design” folder, thereby incorporating a concept of time into the current hierarchical structure by using folder names or file names.

Files can also be arranged by the creation date by rearranging icons in the folder.

However, in a networked file-sharing environment in which multiple users manage and use the same files, names that can be understood by others must be assigned if folder names and file names are used for time-based file management.

Furthermore, the current concept of managing folders based on a time attribute of each folder typically references the folder creation date. If the folders are also named so they can be managed using time information in the folder name, but the folders are sorted chronologically based on the creation (or modification) date attribute of the folders, the folders may be arranged in an order different from the order determined by the folder names. What's more, the sorting order is based on the folder creation date attribute, which is completely unrelated to the date attributes of the subfolders and files stored inside each folder.

If icons inside each folder are arranged in chronological order they can be arranged in order by creation date with no relationship to the file name. The resulting display is a simple file listing, however, and the temporal distance between individual files is not readily knowable. If, for example, “file A” and “file B” are displayed in chronological order in the same folder and “file A” was created first, the chronological relationship between files A and B, that is, how long after file A was file B created, cannot be known immediately. This is because folders as currently used are simply containers and do not have any concept of temporal space.

The present invention is directed to solving these problems, and an object of the invention is to provide a directory management program, an object display program, a directory management method, and a directory management apparatus for organizing and cataloging information using the time base as an important factor by imparting a concept of temporal width to the current concept of folders and also arranging files managed inside the folder along a time line.

### SUMMARY OF THE INVENTION

To achieve the above objects, a directory management program according to the present invention runs on a computer a process for setting a directory management parameter and a time line parameter for a specific object, and a process for linking the object based on the values of the directory management parameter and time line parameter to a particular cell in a directory matrix defined by the directory management parameter and time line parameter.

The invention also provides an object display program for running on a computer a process for setting a directory management parameter and a time line parameter for a specific object, and a process for displaying the object based on the values of the directory management parameter and time line parameter linked to a particular cell in a directory matrix defined by the directory management parameter and time line parameter.

This object display program preferably also runs on the computer a process for displaying multiple objects having the same directory management parameter setting in a sequential order based on the relative magnitude of the time line parameter value of each object.

Yet further preferably, this object display program also runs on a computer a process for linking and displaying an object in a cell of the directory matrix with a scale different from the scale set by the time line parameter.

Yet further preferably, this object display program also runs on a computer a process for receiving a command to change the display order of multiple objects associated with a particular cell of the directory matrix, and a process for moving and displaying the objects in the axial direction of the directory management parameter based on the received change-display-order command.

Yet further preferably, this object display program also runs on a computer a process for setting the values of multidimensional parameters for a specific object, and a process for displaying the object linked to a particular cell of a directory matrix defined by the multidimensional parameters based on the multidimensional parameter settings of the object.

Yet further preferably, this object display program also runs on a computer a process for storing multiple objects linked to a particular cell of the directory matrix, and a process for displaying multiple linked objects as a single icon.

Yet further preferably, this object display program also runs on a computer a process for receiving a command to open the multiple objects displayed as a single icon, and a process for opening and displaying the multiple objects based on this open command.

A directory management program according to the present invention runs on a computer a process for setting the values of multidimensional parameters for a specific object, and a process for linking the object to a particular cell of a directory matrix defined by the multidimensional parameters based on the multidimensional parameter settings of the object.

Preferably, this directory management program also runs on a computer a process for storing multiple objects linked to a particular cell of the directory matrix.

Yet further preferably, this directory management program also runs on a computer a process for defining a correlation between multiple objects associated with a particular cell of the directory matrix.

Yet further preferably, this directory management program also runs on a computer a process for creating a project comprising one or multiple cells of the directory matrix, and a process displaying the objects linked to the one or multiple cells of the project.

A further directory management program according to the present invention runs on a computer a process for setting the value of a first directory management parameter and the value of a second directory management parameter for a specific object, and a process for linking the object to a particular cell of a directory matrix defined by the first and second directory management parameters based on the first and second directory management parameter values of the object.

The invention is also characterized by a computer setting a directory management parameter and a time line parameter for a specific object, and linking the object based on the values of the directory management parameter and time line parameter to a particular cell in a directory matrix defined by the directory management parameter and time line parameter.

A directory management apparatus according to the present invention has means for setting a directory management parameter and a time line parameter for a specific object, and means for linking the object based on the values of the directory management parameter and time line parameter to a particular cell in a directory matrix defined by the directory management parameter and time line parameter.

In another aspect, the invention involves an apparatus for performing the directory management program and object display program. The apparatus, which may be a computer or network comprises components configured to carry out the processes described above. Such components may be embodied in a processing device, which may comprise one or more integrated circuit chips. The processing device may comprise any combination of the following: central processing unit (CPU), application specific integrated circuit (ASIC), and digital processing circuitry. The processing device may be controlled by software.

In accordance with further aspects of the invention, the above-described method or any of the steps thereof may be embodied in a program of instructions (e.g., software) that may be stored on, or conveyed to, a computer or other processor-controlled device for execution. Alternatively, the method or any of the steps thereof may be implemented using functionally equivalent hardware (e.g., ASIC, digital signal processing circuitry, etc.) or a combination of software and hardware.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows a typical window design in which objects are displayed along a time line in a preferred embodiment of the invention;

FIG. 2 shows the window in FIG. 1 after a folder is opened;

FIG. 3 shows how screens of different types are related in the present invention;

FIG. 4 shows a listing of subfolders and files in a folder in this embodiment of the invention;

FIG. 5 shows the login screen 321 in this embodiment of the invention;

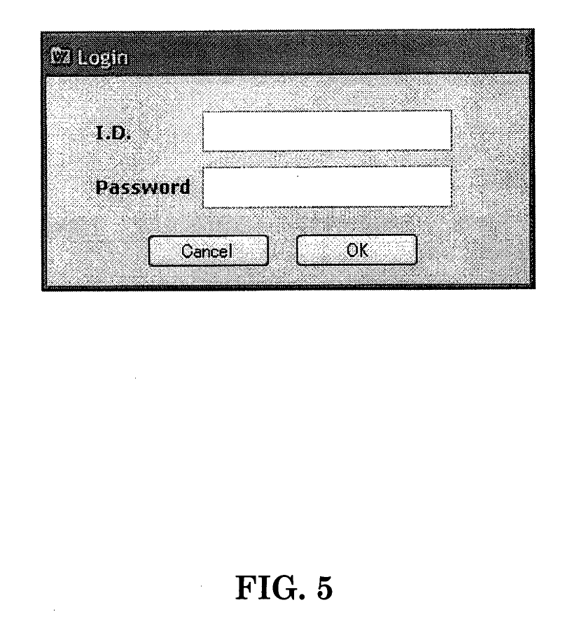

FIG. 6 shows files in a subfolder displayed along a time line in this embodiment of the invention;

FIG. 7 shows an example of a chronologically sequenced content slide show in this embodiment of the invention;

FIG. 8 shows using a button 801 to open a folder at a lower hierarchical level in this embodiment of the invention;

FIG. 9 shows opening windows to reach a desired file in this embodiment of the invention;

FIG. 10 shows expanding the viewing range in this embodiment of the invention;

FIG. 11 shows selectively displaying projects by using the display checkboxes and display switch in this embodiment of the invention;

FIG. 12 shows selectively displaying projects by using the display checkboxes and display switch in this embodiment of the invention;

FIG. 13 shows selecting folders to display by using a display filter in this embodiment of the invention;

FIG. 14 shows displaying only the selected Project folders in this embodiment of the invention;

FIG. 15 shows an example of changing the scale of the time line 1502 in this embodiment of the invention;

FIG. 16 shows an example of changing the scale of the time line 1502 in this embodiment of the invention;

FIG. 17 shows displaying only past files referenced to the current date in this embodiment of the invention;

FIG. 18 shows a thumbnail sketch display of image files in this embodiment of the invention;

FIG. 19 shows displaying objects on different time lines in different stacked panes in the same window in this embodiment of the invention;

FIG. 20 shows displaying a particular project on a different time line in a separate pane stacked on the same window in this embodiment of the invention;

FIG. 21 shows displaying cells with different time lines in vertically split panes in this embodiment of the invention;

FIG. 22 shows creating a Project folder in this embodiment of the invention;

FIG. 23 shows entering project attributes in this embodiment of the invention;

FIG. 24 shows entering the project schedule in this embodiment of the invention;

FIG. 25 shows expanding the new project in this embodiment of the invention;

FIG. 26 shows saving an object file using the Recent Filed Link tool of this embodiment of the invention;

FIG. 27 shows saving an Observation file 2701 in the Research folder of Project 04 in this embodiment of the invention;

FIG. 28 shows moving a file from the client to the destination folder on the server in this embodiment of the invention;

FIG. 29 shows displaying a project on an independent time line in a stacked pane when there is a large difference between object time lines and all objects cannot be displayed on the same time line in this embodiment of the invention;

FIG. 30 shows a data entry screen for time management in this embodiment of the invention;

FIG. 31 shows displaying hours consumed with a bar graph in this embodiment of the invention;

FIG. 32 shows an example of an index print in this embodiment of the invention;

FIG. 33 shows a directory printout in this embodiment of the invention;

FIG. 34 shows displaying the project screen 311 in this embodiment of the invention;

FIG. 35 shows displaying the shared information screen 3502 in this embodiment of the invention;

FIG. 36 shows displaying the data entry screen 3601 in this embodiment of the invention;

FIG. 37 shows confirming the content of a saved object in this embodiment of the invention;

FIG. 38 shows sending a search string from the project screen to the knowledge screen in this embodiment of the invention;

FIG. 39 shows sending a search screen from the project screen to the knowledge screen in this embodiment of the invention;

FIG. 40 shows copying information stored in the shared information screen 310 to the project screen in this embodiment of the invention;

FIG. 41 shows copying information stored in the knowledge screen to the project screen in this embodiment of the invention;

FIG. 42 shows linking comments about a “Question” file stored in the Research process of Project 04 to the Question file in this embodiment of the invention;

FIG. 43 shows an example of a screen in which grouped icons are shown visually linked in this embodiment of the invention;

FIG. 44 shows displaying the content of grouped icons in this embodiment of the invention;

FIG. 45 shows a conventional directory management hierarchy;

FIG. 46 describes the concept of a directory matrix in this embodiment of the invention;

FIG. 47 shows a two-dimensional directory matrix with category and time line axes in this embodiment of the invention;

FIG. 48 shows a two-dimensional directory matrix with OS-level category and application-level category axes in this embodiment of the invention;

FIG. 49 shows conventional directory management;

FIG. 50 shows displaying subfolders and files in a directory object in this embodiment of the invention;

FIG. 51 shows adding to the directory matrix in this embodiment of the invention;

FIG. 52 shows moving an object from one cell to another cell of the directory matrix in this embodiment of the invention;

FIG. 53 shows displaying scroll bars in an active cell of the directory matrix when all cell contents cannot be shown in the cell at the same time in this embodiment of the invention;

FIG. 54 shows a process for adding a subdirectory to the vertical axis of OS-level categories in this embodiment of the invention;

FIG. 55 shows adding an untitled category and empty matrix cells to the parent directory in this embodiment of the invention;

FIG. 56 shows selecting a particular directory when the time line is displayed horizontally in this embodiment of the invention;

FIG. 57 shows displaying subdirectories and files of a particular directory in a separate window in this embodiment of the invention;

FIG. 58 shows displaying subdirectories and files of a particular directory in a separate window in this embodiment of the invention;

FIG. 59 shows moving a cell border of the directory matrix in this embodiment of the invention;

FIG. 60 shows displaying one object per line in this embodiment of the invention;

FIG. 61 shows displaying object content in thumbnail sketches of the object content in this embodiment of the invention;

FIG. 62 shows moving thumbnail icons freely in the right pane according to the progress of the project while the object listing in the left pane remains in chronological order in this embodiment of the invention;

FIG. 63 shows how displaying object file names can be switched on and off in this embodiment of the invention;

FIG. 64 shows using symbols and attributes to visually represent the relationship between displayed object icons in this embodiment of the invention;

FIG. 65 shows displaying file attributes by moving the pointer over an object icon in this embodiment of the invention;

FIG. 66 shows an example of action items that can be managed for a project in this embodiment of the invention; and

FIG. 67 shows an example of project action items with completion of an action item indicated by a checkbox in this embodiment of the invention.

FIG. 68 is a block diagram of an exemplary processing system that may be used to implement embodiments of the methods and processes of the present invention.

### DESCRIPTION OF THE PREFERRED EMBODIMENTS

The underlying concept of the present invention is described first below.

Objects are managed in today's computers using folders representing directories and icons representing files. To display these objects the present invention adds the concept of time to each object.

A location on the time axis is therefore defined for each object (both folders and files) so that these objects can be sorted in the same way as other data and therefore managed by time. More specifically, the time attributes (such as a date information) of a folder object are synchronized to the time attributes of the objects occupying the next level down in the file hierarchy. The time line parameters of files in a folder therefore determine the time line parameters of the folder.

When there are multiple data objects in a folder there are also plural time attributes, enabling the concept of temporal duration, that is, the period from the date of the oldest object to the date of the newest object (from-to), to be used. If the multiple data objects in a single folder belong to a single project, for example, the time attributes of the oldest object can be set as the time and date of the start of the project period and the time attributes of the newest object can be used as the time and date of the end of the project period.

Folders and data objects are also placed on the time axis so that the distance between objects indicates the time difference between the objects.

This enables folders to be used as a tool for managing a group of related jobs such as “projects,” “processes,” and “tasks” having length along the time line.

As used herein, an “object” is a data management object such as a folder or file.

Furthermore, adding a concept of time to folders means managing time stamps independently of time stamps normally managed by the computer's operating system at the OS level or an application level above the OS level.

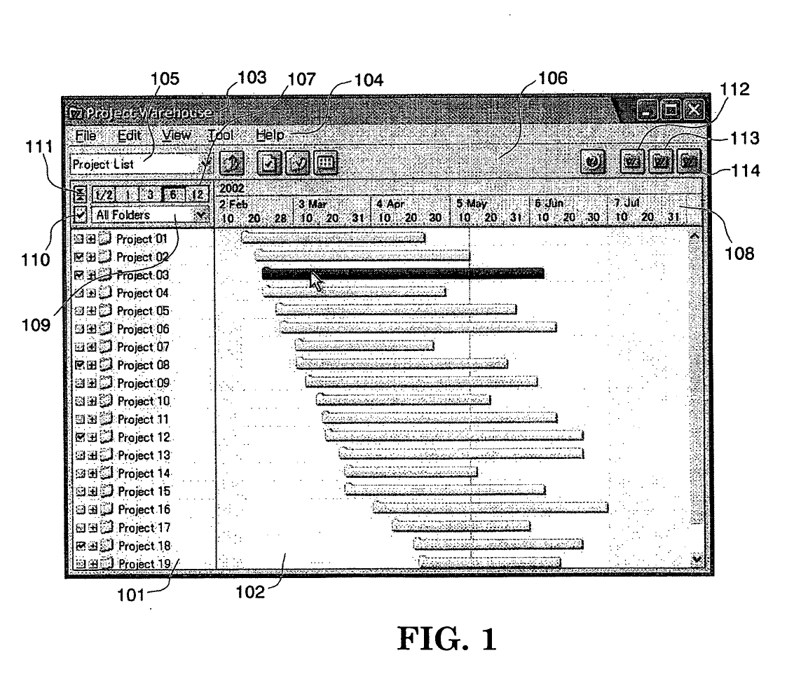

FIG. 1 shows directory management using the folder concept of the present invention. This is similar to the concept of directory management that is commonly used with computers, and by using a common desktop metaphor and a standard, commonly used GUI having windows, folders, and contextual menus, for example, is easy to understand for first-time users.

Folders for Project 01 to Project 19 are displayed in the left pane 101 of the window. The right pane 102 shows time in the horizontal direction. The folders listed in the left pane 101 are displayed with length along the time line in right pane 102, thereby imparting a visual representation of time, specifically temporal length, to each of the project folders listed in the left pane 101. The distance between the left and right ends of each project folder in the right pane 102 thus represents the amount of time allocated to each folder.

The time allocated to each folder is determined by the time stamp of the start of the project period and the time stamp for the end of the project period, and can be set as desired by the user. It can therefore be known from this graphical representation that Project 08, for example, is to last from approximately March 1 to May 20. The time width of each folder can be set from the folder properties setup dialog further described below.

As will be known from FIG. 1, if Project 01 to Project 19 are all different projects, the temporal overlap between projects can be readily known from the figure.

Furthermore, if Project 01 to Project 19 represent individual steps in a larger project, the current progress of each project can also be readily visually determined.

If the projects are sorted by project manager, the workload of each manager at a particular point in time can also be visually assessed.

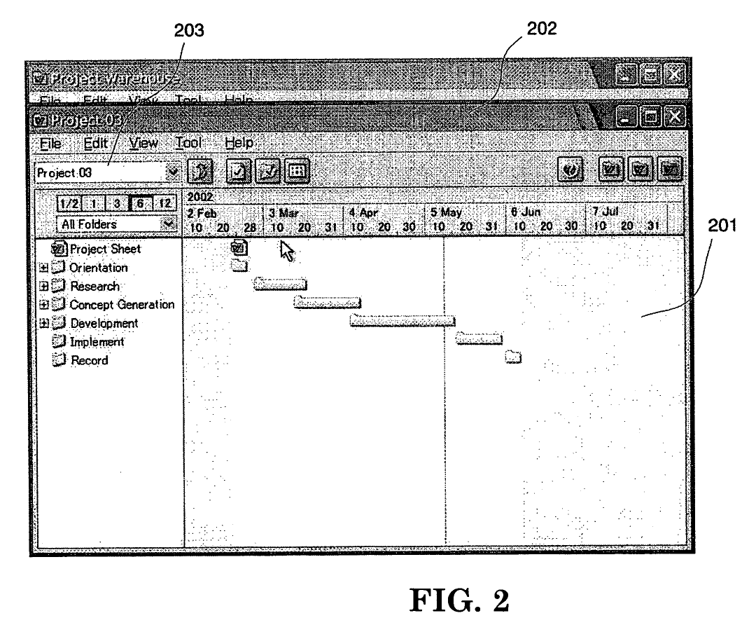

If the Project 03 folder is opened, for example, information relating to Project 03 is also displayed arranged along the time line as shown in FIG. 2, and what tasks were performed when can also be visually determined.

Using the folder concept of the present invention makes it possible to manage information relating to linked tasks with reference to the passage of time. The folders of the present invention can therefore be used for a wide range of applications, including acquiring systematic information and knowledge by following information referenced to time rather than simply tracking the information, learning through past experience, and continuing or reflecting past experience in current operations.

Time-based management of such information also enables an individual user to track his own work history and use the information for a personal job evaluation or record of growth and improvement.

Managers can also use the same information for individual job evaluations and as a project management tool.

Basic Screen Configuration

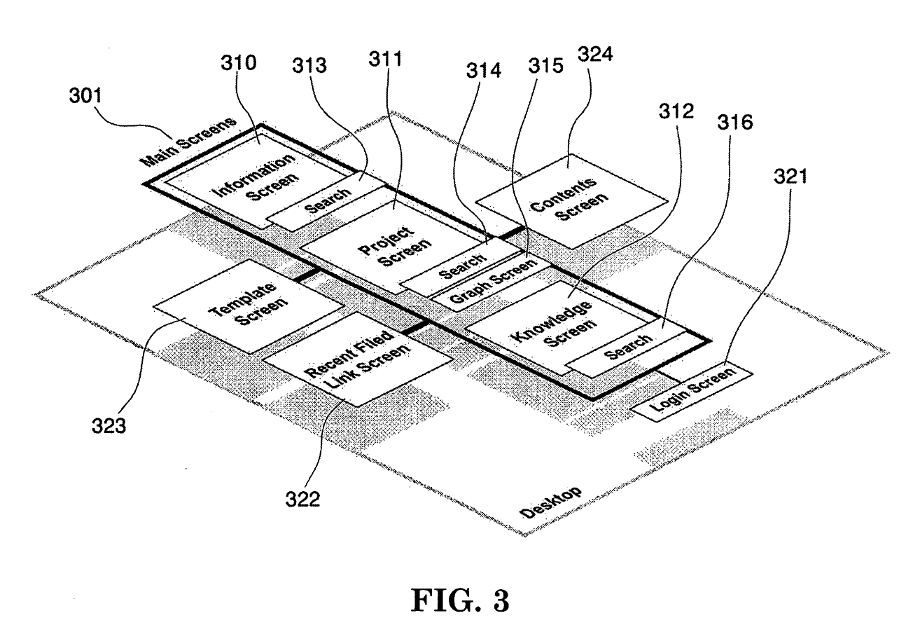

FIG. 3 shows the screen configuration of the present invention, including main screens 301 for displaying projects, knowledge, and shared information, and a number of subscreens controlling input/output to the main screens 301.

The main screens are described first. There are three main screens 301, the shared information screen 310, project screen 311, and knowledge screen 312, respectively having the following functions.

1) Shared Information Screen 310

This screen is for presenting general information not associated with a specific project, such as memos, news, and libraries. For example, information such as communications within a department, industry news, and templates for shared documents are presented in this shared information screen. A search screen 313 for finding necessary shared information is also included in this shared information screen.

2) Project Screen 311

This is a screen such as shown in FIG. 1 and FIG. 2 for displaying projects, and displays the hierarchy of the Project, Process, or Task, for example, and the files stored therein. There is also a search screen 314 for project searching, and a graphing screen 315 for displaying a graph of some part of the data.

3) Knowledge Screen 312

This screen is for displaying guidelines, techniques, methods, and other more general knowledge relating to performing a job rather than pertaining to a specific project, and includes a search screen 316. While the shared information screen 310 displays temporary information that gets updated, the knowledge screen 312 displays more specialized, general academic knowledge.

The sub-screens described next below are what control input to and output from these main screens 301. There are four sub-screens as follow.

1) Login screen 321

A screen for logging in to this system.

2) Recently stored files screen 322

Shortcuts to files stored by an application are displayed in this screen, which is normally resident in the background.

3) Template screen 323

A screen for entering data not dependent on an application.

4) Content screen 324

A screen for displaying files stored on a server.

The recently stored files screen 322 is displayed for applications run on the client side, and other applications are all run on the server side and displayed on the client side.

Of these sub-screens the recently stored files screen 322 and template screen 323 in particular are used as input screens for inputting files to the main screens 301.

Shortcuts (aliases) to files stored by an application are displayed in the recently stored files screen 322, and a shortcut can be moved to copy the file referenced by the shortcut to the server and register the file on the main screen.

The template screen 323 is used for inputting data not dependent on an application, and data can be input to the main screens 301 by selecting an appropriate template and inputting data (such as text and images) to the template.

Other input methods include input from the desktop and between main screens. The desktop is a method for copying and directly registering files on the desktop in a main screen. Between main screens refers to a method for registering files by copying files registered in the shared information screen 310, for example, to a project screen 311.

Basic Screen Layout

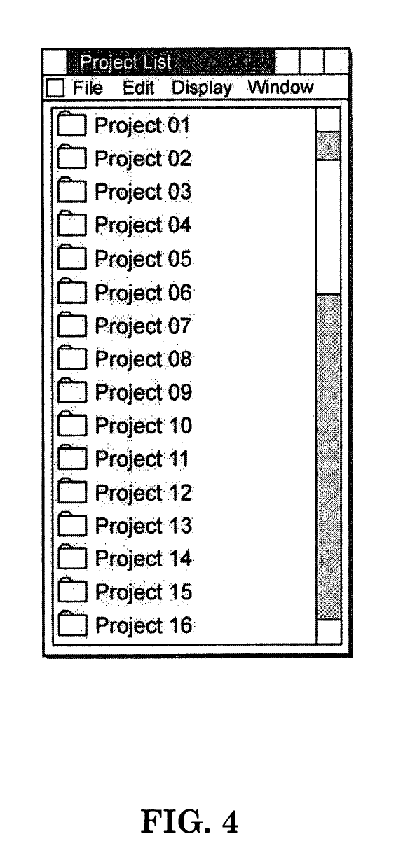

The basic layout of the main screen is described below with reference to the accompanying figures. While there are variations in icon size and arrangement in a normal GUI, objects (subfolders and files) inside a folder are displayed as shown in FIG. 4.

As shown in FIG. 1, a list of the objects is placed in the left pane 101 of the main screen displayed by the present invention, maintaining compatibility with the common file management display methods current today. That is, using a directory matrix drawn in two-dimensional space, the vertical axis is an object list.

Our invention adds a time axis to this directory matrix. More specifically, the horizontal axis of this directory matrix is a time line against which the objects are displayed using the time attribute of each object.

This concept can be applied to the GUI of the OS by, for example, adding a “calendar display” selection to a menu for selecting how the contents of a folder are displayed so that when this “calendar display” item is selected the folder content is displayed as shown in FIG. 1. The display could also be changed using a “show information” such as conventionally used.

The project screen 311, shared information screen 310, and knowledge screen 312 preferably share a common basic layout for improved usability. If the concept of time is not needed in the knowledge screen 312, however, the knowledge screen 312 could be displayed without a calendar view option. Content screens 324 also preferably use a common layout, but the layout can be changed as appropriate or necessary. This is because the content screen 324 cannot usually be edited by anyone other than the author and is the topical focus of the display.

The basic screen configuration has from the top of the screen a title bar 103, menu bar 104, directory (path) bar 105, and a toolbar 106. A time scale button 107 for changing the time scale 108 is located below the directory bar 105. Below the time scale button 107 is an Abstract button 109, and to the side are a display switch 110 and Compressed List View button 111. The function of each button and switch is described below.

Basic Operation

(1) Open, Expand

The basic operation of the main screens is described using the project screen by way of example.

The login screen 321 is first activated and the required ID and password are entered to log in to the system.

When login is finished the display settings and the screen displayed when operation last ended are restored. For example, if only projects managed by the user are usually displayed in the project screen 311, the system starts up in the same condition and work with the files can start immediately.

A project screen 311 is presented first as shown in FIG. 1. “Project Warehouse” is displayed in the title bar 103 so that the user knows that the currently active screen is the project screen. If the selected screen is the shared information screen or knowledge screen, the title bar changes to “Information Warehouse” or “Knowledge Warehouse,” respectively. While all viewable projects can be displayed in the project screen 311, the projects can also be displayed sorted by project manager, or the display could be switched to display only the desired folders. The main screen displays enable the temporal relationship between multiple displayed projects to be seen at one time.

When Project 03, one of the Project folders displayed in the right pane 102 of the window, is opened, a new window 201 for Project 03 is opened in the project screen as shown in FIG. 2, and the contents (objects) stored in Project 03 are displayed in the project window. Note that there are multiple subfolders and files (objects) in Project 03. These subfolders are also displayed with a length corresponding to the duration of the object over time as determined from the start and end time attributes as described above.

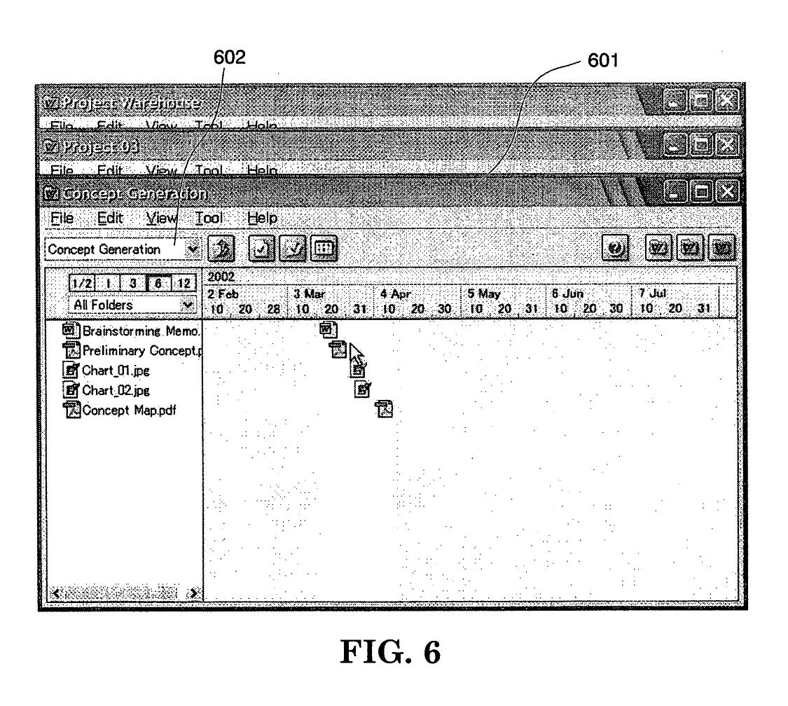

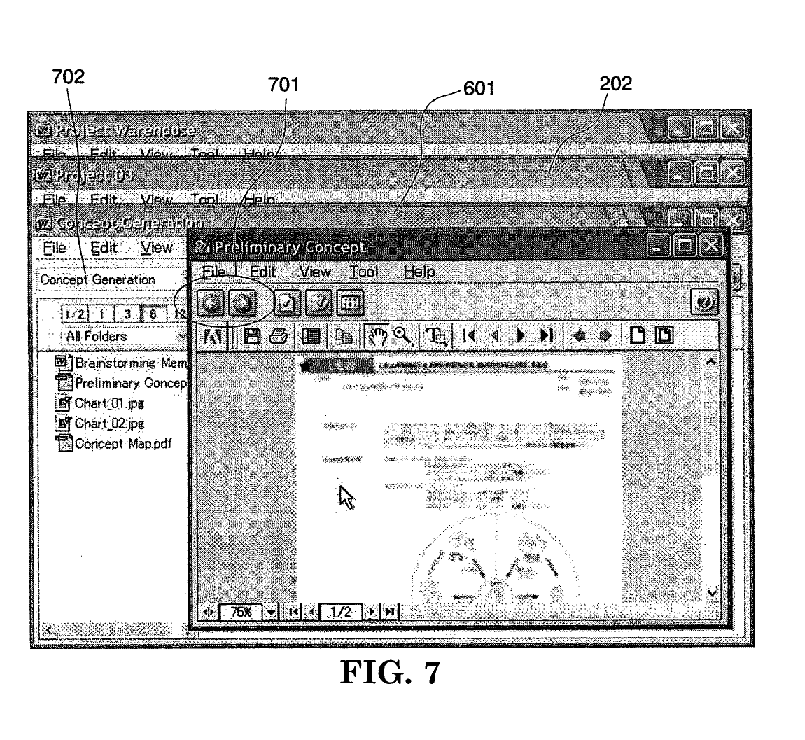

When the Concept Generation subfolder is opened the files contained therein are displayed in chronological order as shown in FIG. 6. When one of these files, such as the Preliminary Concept file, is then selected, another window is opened and the contents of the Preliminary Concept object are displayed (FIG. 7). To view a different file in the same subfolder, the next file in chronological order (such as Chart_{—}01.jpg in FIG. 6) can be displayed by simply pressing one of the navigation buttons 701 located in the top left of the window without closing the window of the file being viewed.

Tabs are also displayed on the title bar so that when multiple windows are open at the same time the depth of the currently active folder in the folder hierarchy can be known at a glance as will be understood from FIG. 2, FIG. 6, and FIG. 7. Overlapping tabs 202, 601 that become shorter as the file hierarchy is descended are displayed so that the hierarchical depth can be understood visually. The directory path to the current window is also displayed under the menu in the directory bar 203, 602, 702.

Operation is described here using the project screen 311 by way of example, but registered files can be displayed as a content screen 324 using the same operation in the shared information screen 310 or knowledge screen 312. The project screen 311, shared information screen 310, and knowledge screen 312 are also designed so that the color of the title bar changes according to the displayed content so that the user can easily visually determine what screens are open.

The project screen 311, shared information screen 310, and knowledge screen 312 also have navigating buttons 112, 113, 114 for quickly switching and displaying the desired main screen.

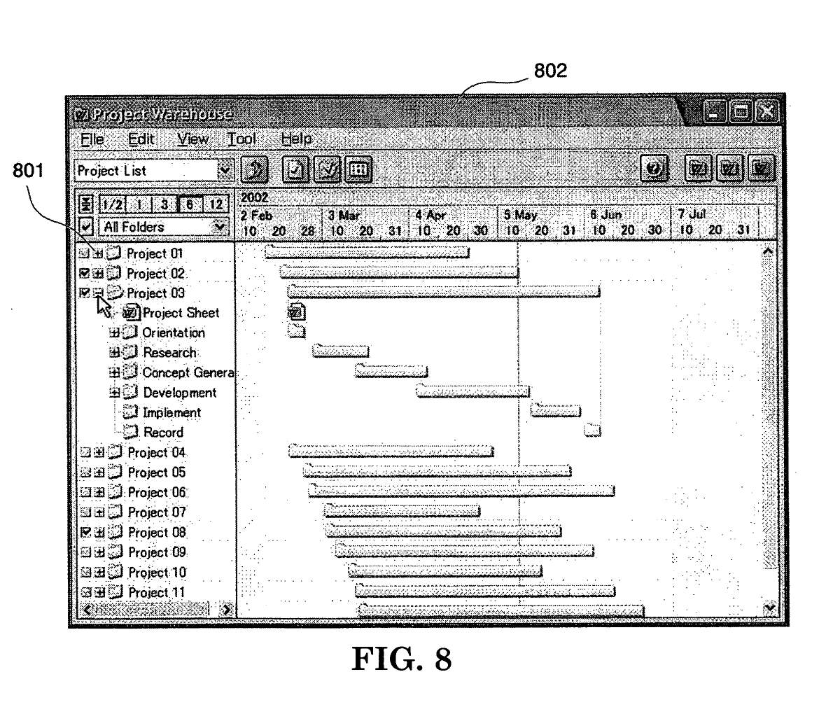

Furthermore, in the example shown in FIG. 2 the hierarchy was descended by opening folders in the right pane 102 of the window. As shown in FIG. 8, however, the buttons 801 displayed to the left of each object icon in the left pane of the window can be clicked to expand and collapse the file/folder hierarchy and open individual folders.

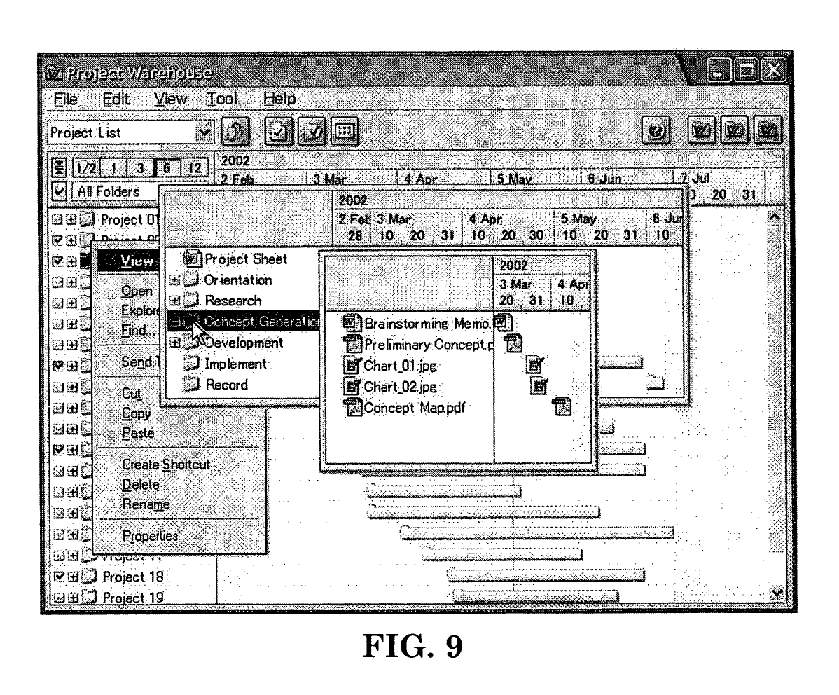

The directory can also be navigated as shown in FIG. 9 by selecting a folder in the left pane of the window and displaying a contextual menu, then selecting View from the menu to open a window for viewing the desired file.

If the user wants to view a different file in the same folder after opening a file in the desired folder, the navigation buttons 701 displayed at the top left part of the window can be clicked to open a different file in the same folder without returning to a higher level in the hierarchy.

The content screen 324 shown in FIG. 7 basically has the same functions as a browser and can display the content of all file types that can be displayed by a browser. Clicking on the navigation buttons 701 shown at the top left of the screen navigates to the next file in chronological order (older or newer). If the forward navigation button 701 is clicked after viewing the newest file in a given subfolder (i.e., the last file), the next subfolder in chronological order (the newest in this case) is opened and the contents of that subfolder are then displayed.

In other words, multiple objects for which the file management parameter (further described below) is set to the same value can be displayed in sequence based on the relative magnitude of the value of the time line parameter. If a time line parameter is used, the relative value of the time line parameter determines the chronological order of the listing; if file (object) names are used, the alphabetical or phonetic order of the listing can be defined. It should be noted that if a folder contains both files and subfolders, all objects (files and folders) are preferably displayed in chronological order, such as oldest to newest.

This action of continuously viewing content as described above is referred to herein as a “content slide show.” The content slide show is set up to enable moving between subfolders. One continuous process can therefore be viewed in a continuous slide show such that, for example, after viewing the results of data collection the content of the following design process can also be viewed.

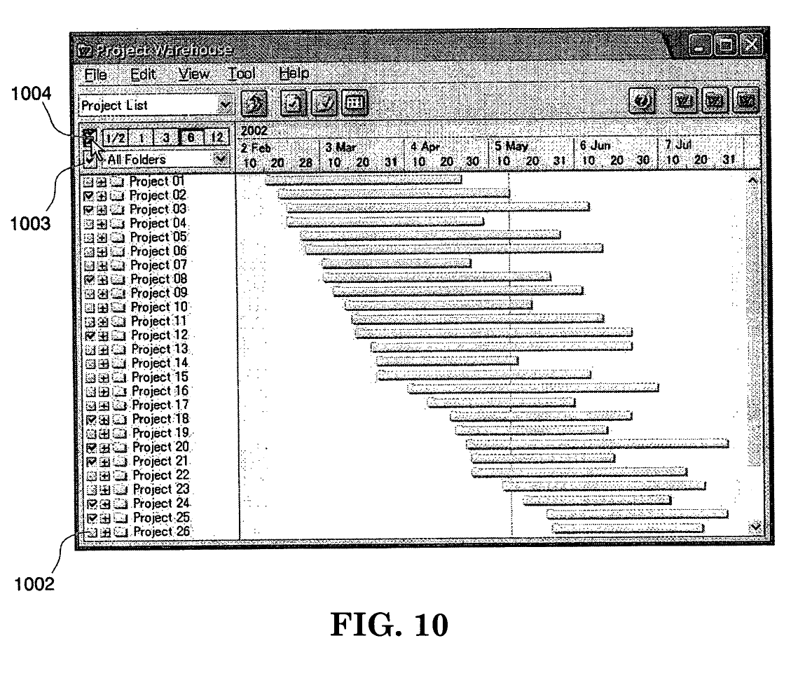

A large number of projects can also be viewed at one time by clicking on the compressed list view button 1004 as shown in FIG. 10. This reduces the display so that more objects can be displayed without scrolling the window.

Conversely, it is also possible to selectively display a desired project.

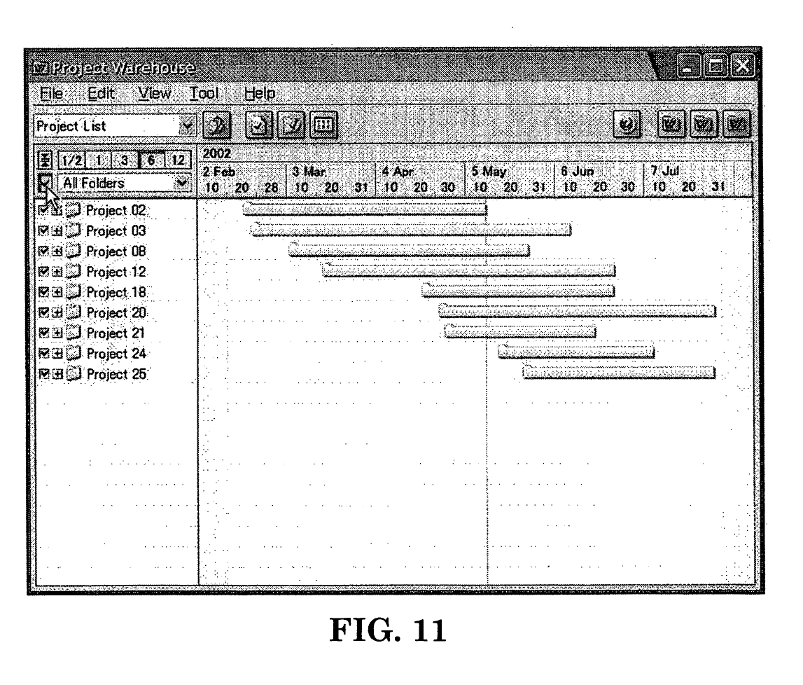

FIG. 10 and FIG. 11 show a method for selectively displaying projects using a display checkbox.

As shown in FIG. 10, a display checkbox 1002 is provided beside each object listed in the left pane of the project screen. By selecting the display checkbox 1002 (so that a check is shown) for those objects (projects in this case) to be displayed and then clicking the display switch 1003, the project screen displays only those objects for which the display checkbox 1002 has been checked. Deselecting the display checkbox 1002 for any object cancels selection of that object, which is then removed from the display.

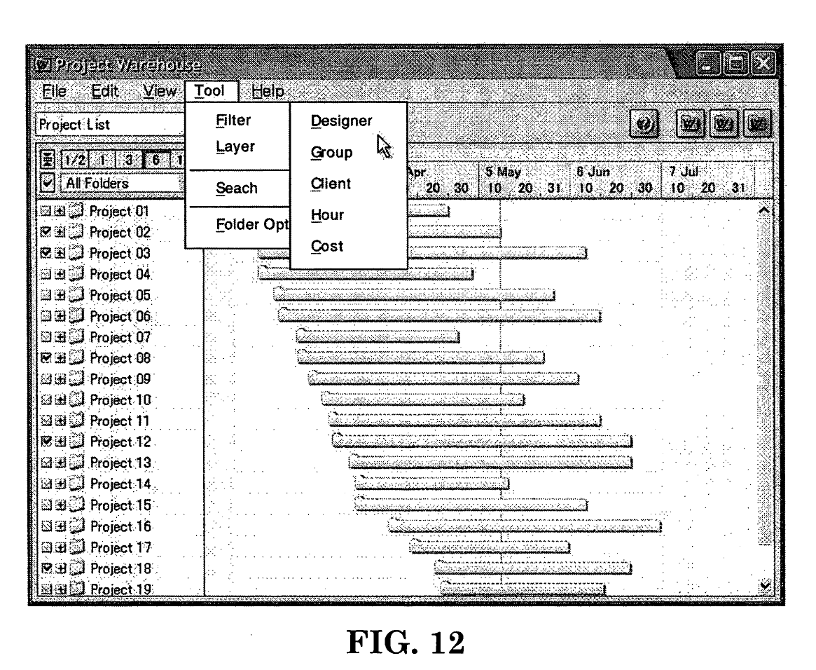

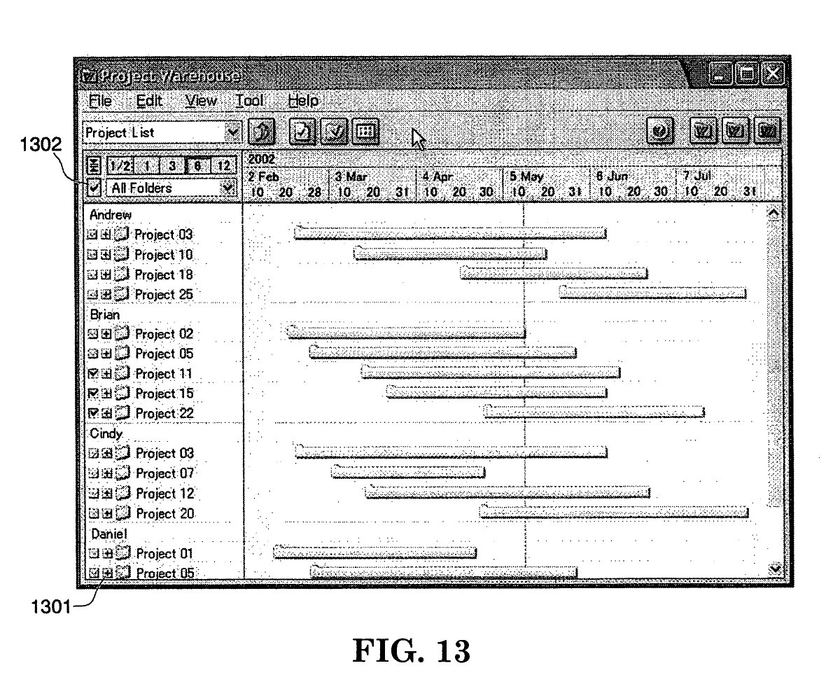

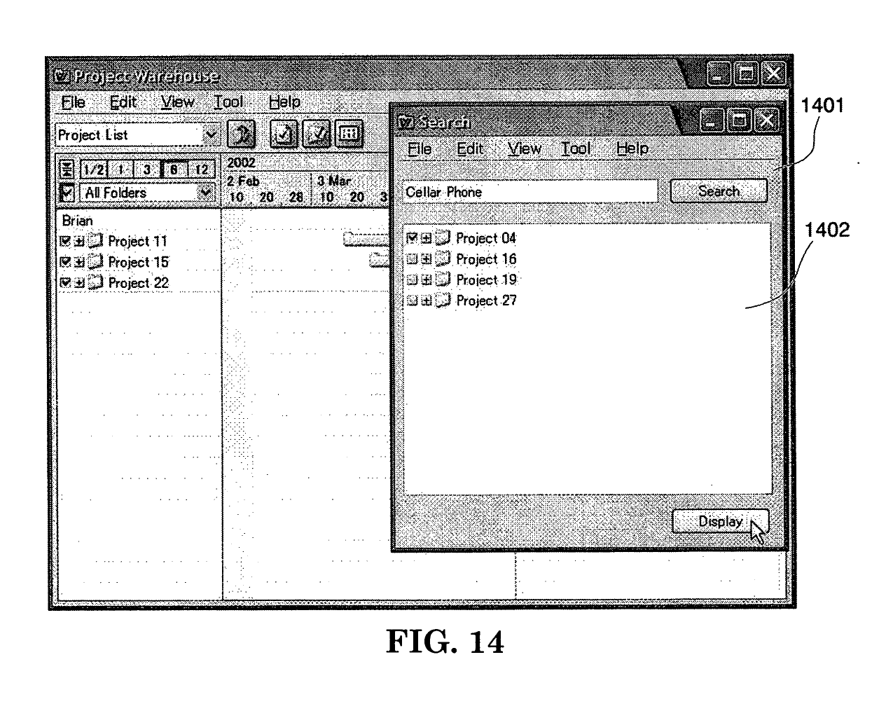

Display filters can also be used to select which folders are displayed as shown in FIG. 12 and FIG. 13. The displayed folders can be grouped by designer as shown in FIG. 13, for example, by selecting “Designer” from the Tool-Display Filter menu item as shown in FIG. 12. The display checkboxes 1301 can also be used in this case to further control which folders are displayed. By selecting only Projects 11, 15, and 22 for the designer “Brian” in FIG. 13 and then clicking the display switch 1302, the project screen is redrawn to display only the selected project folders as shown in FIG. 14.

Another way to display only certain folders is by searching. If the Tool-Search menu item is selected from the project screen shown in FIG. 14, a search dialog 1401 is displayed. The user can then enter the search words, such as “cellular phone” and click the search button to find and display only the relevant folders as shown in the search results 1402. The display checkboxes can, of course, also be used here to further control what is displayed.

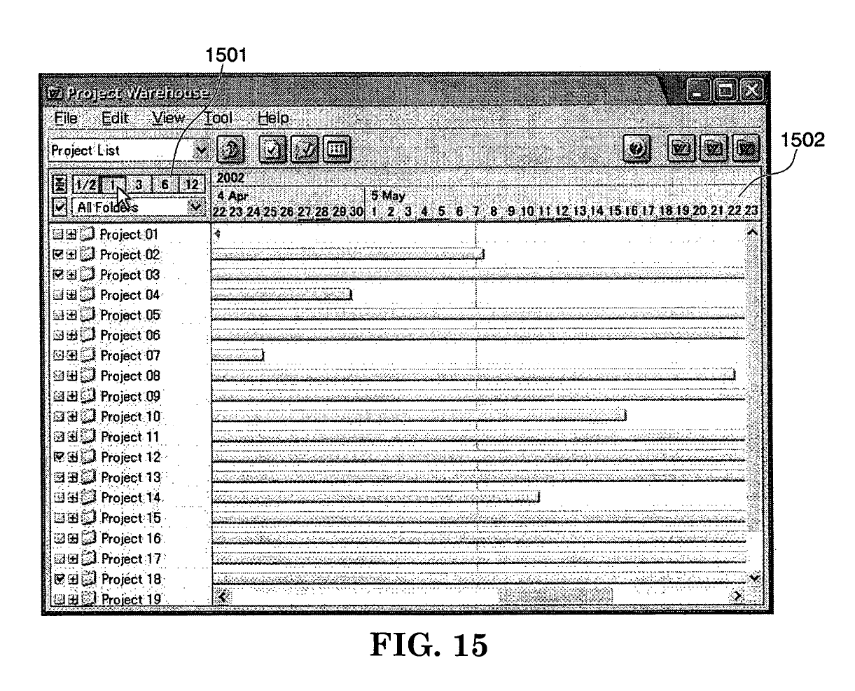

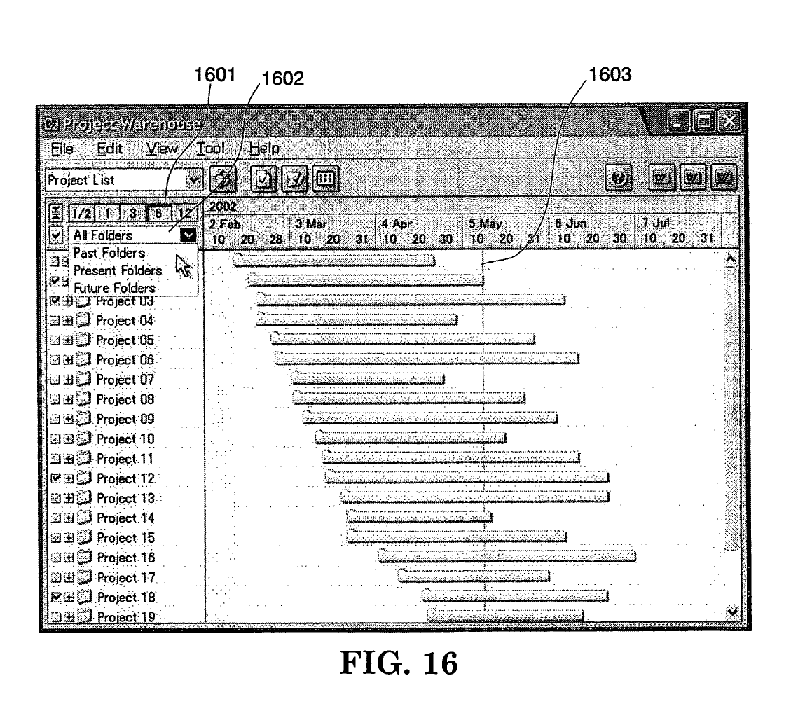

Methods of displaying the folders selected by any of the above methods are described next. The time scale button 1501 in FIG. 15 controls the display unit of the time line 1502, and can be set to various intervals ranging from semi-monthly to twelve months. FIG. 15 shows the “1” time scale button 1501 selected so that the time line 1502 covers a period of one month. FIG. 16 shows another example in which the “6” time scale button 1601 is selected to display a six-month period of time. The length of the time line can thus be adjusted as needed by using the time scale buttons 1501 and 1601.

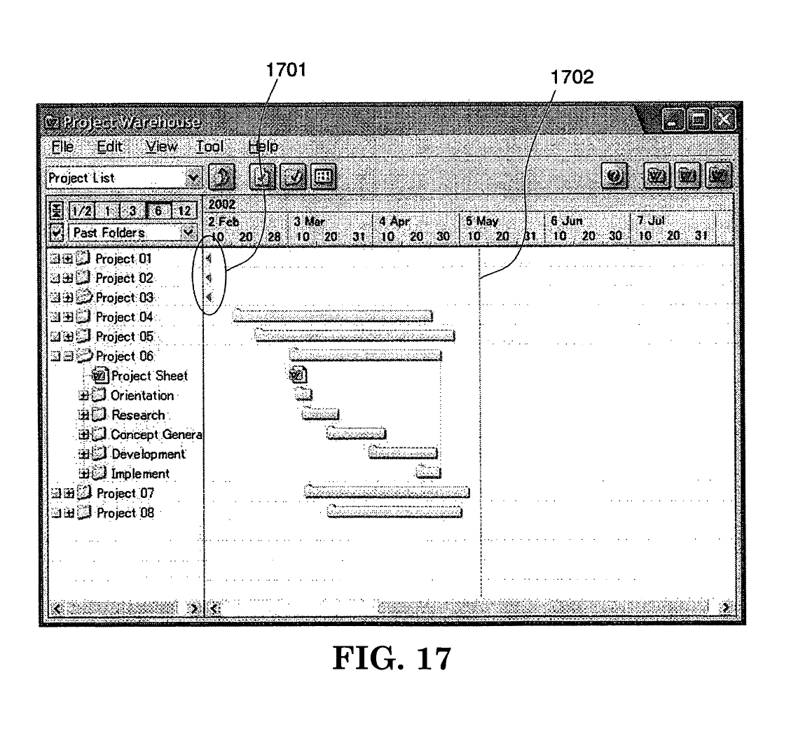

A pull-down menu can also be used to change the displayed files. When this menu 1602 is clicked, “Past Folders,” “Present Folders,” and “Future Folders” selections are displayed as shown in FIG. 16. This menu groups and displays the folders as past folders, current folders, and future folders referenced to the current date. For example, if Past Folders is selected in FIG. 16, only files from the past as determined by the current date and time are displayed as shown in FIG. 17. It should be noted that the vertical lines 1603 and 1702 displayed in the middle of the right pane of the window in FIG. 16 and FIG. 17 denote the current date. In the example shown in FIG. 17 we know from the position of line 1702 that the current date is approximately May 6.

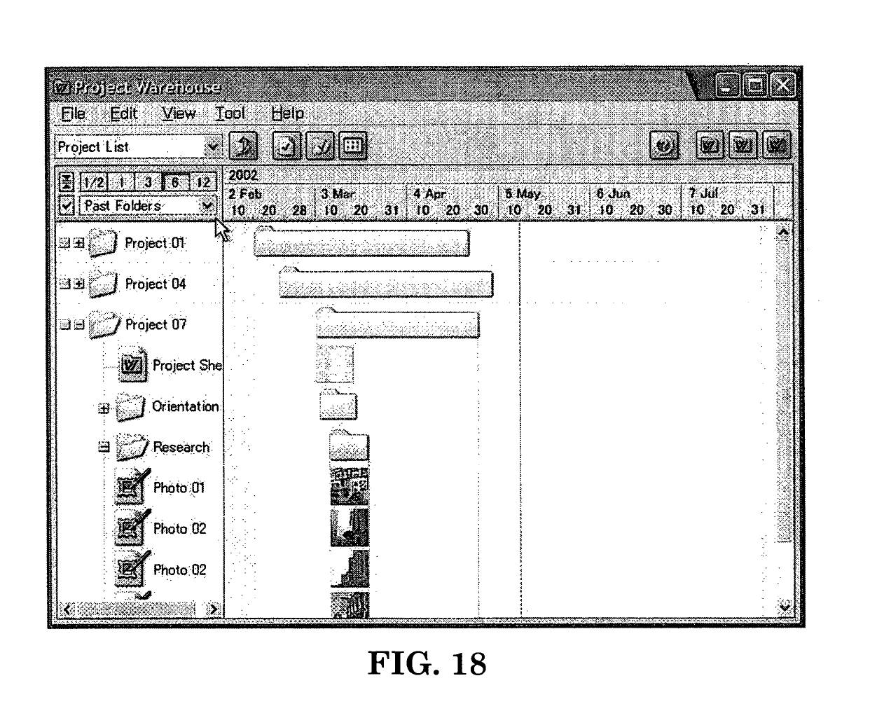

Thumbnail sketches of image files can also be displayed as shown in FIG. 18. Thumbnail sketches of image files are displayed when Large Icon (not shown in the figure) is selected from the View menu.

If the calendar display exceeds the size of the window, the remainder can be seen by scrolling the window horizontally. The scroll bar is positioned the same as in a normal window, and the calendar dates also scroll in conjunction with the displayed content. The distanced scrolled is adjusted to the defined time span of the folders or the time span of internal objects.

If there are folders that cannot be displayed on the time line of the currently displayed window, triangles 1701 denoting the existence of such folders and whether those folders are past or future folders relative to the currently displayed time axis are displayed as shown in FIG. 17. It is known from the example in FIG. 17 that the Project 01 to Project 03 folders are in a period before February 2002. If an undisplayed folder is in the future on the displayed time axis, the corresponding triangle is displayed at the right end of the time line. If one of these triangles is then selected, the display automatically scrolls (jumps) so that the currently undisplayed folders are displayed.

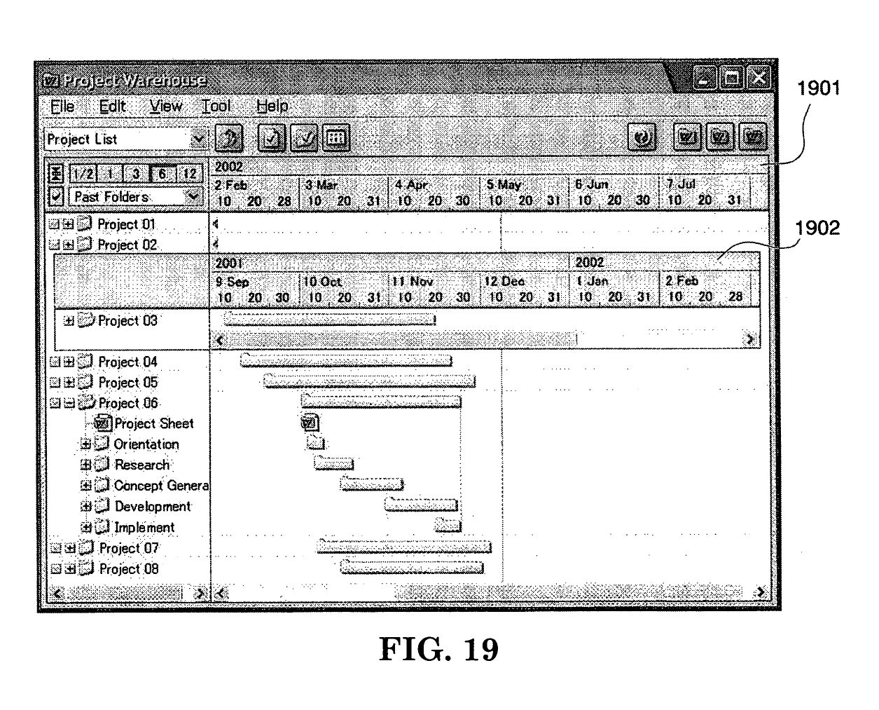

Two projects that cannot be displayed on the same time line, such as Project 03 and Project 06 shown in FIG. 17, can also be displayed by splitting the window into panes having different time lines as shown in FIG. 19. This can be done by, for example, selecting the navigation triangle 1701 for Project 03 to bring up a contextual menu (not shown in the figure) from which a “split window” item can be selected to split the window and open another pane. This opens another pane with a scroll bar and a time line 1902 appropriate to the selected project (Project 03 in this case) displayed separately from the time line 1901 displayed for the current project. The user can therefore separately scroll and view Project 03 and Project 06 on different time lines. In other words, objects can be linked and displayed in a cell having a time line with a different scale than the scale specified by the time line parameter in the corresponding cell of the directory matrix. Note that in the example shown in FIG. 19 the time scale is 6 months for both time lines based on the time line 1901 of the currently active window.

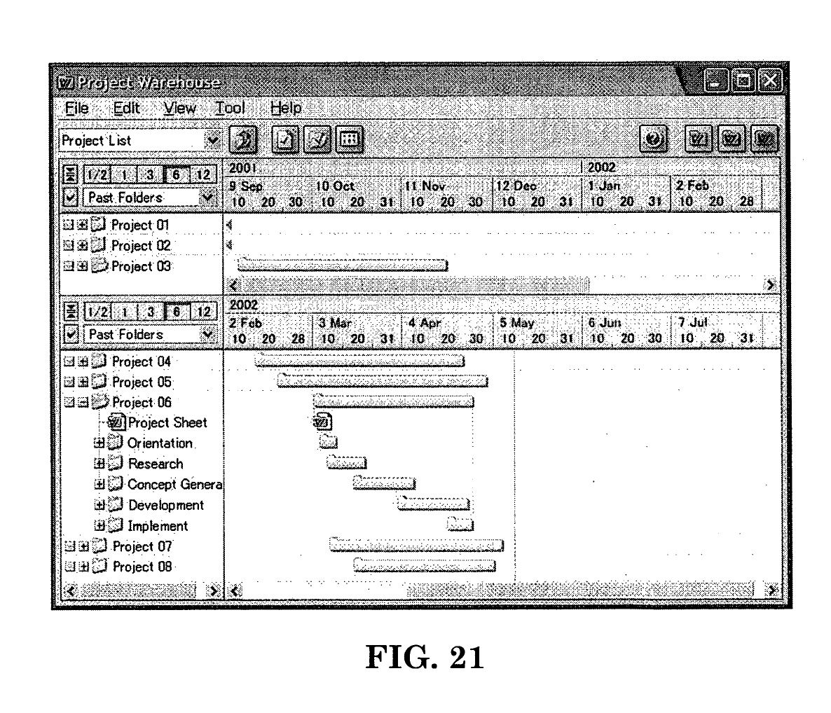

Furthermore, when comparing two projects that cannot be displayed in the same time range, it may be desirable to display the projects using relative time lines rather than comparing absolute time lines. In this case the window can be split into separate panes from a menu selection as described with reference to FIG. 17 above so that objects (or cells) can be displayed on different time lines in separate vertical panes as shown in FIG. 21. The position of the calendar separating the top and bottom display areas can be moved vertically and positioned between the desired projects with different time lines shown in the top and bottom panes.

Creating a Project

Project folder settings are described next below.

A project folder is a folder that is managed on a server connected over a network to the client terminals of multiple users in a group. A project folder can be created and configured by commands from a client terminal.

1) Name: name of the folder

2) Folder color: color of the folder icon (used for grouping)

3) Period: the intended time span of the folder; used for displaying the folder on the time line. Set by default to the folder creation date acquired from a system time stamp, and denoted as a point on the time line. The folder period is updated according to the date parameters of the objects stored in the folder. More specifically, whenever a new file is saved to the Project folder, the Project folder period is updated to the time stamp of the new file.

4) Manager name: name of the manager of the folder; also used for display filters.

5) Subfolder: folders created inside a folder are subfolders

6) Reference folder: sets a reference folder

In other words, all folders, files, and other objects displayed in the project screen 311 are stored on the server. When a new project is created in the project screen 311, the information required to define the project, including the above items, is also input to the server.

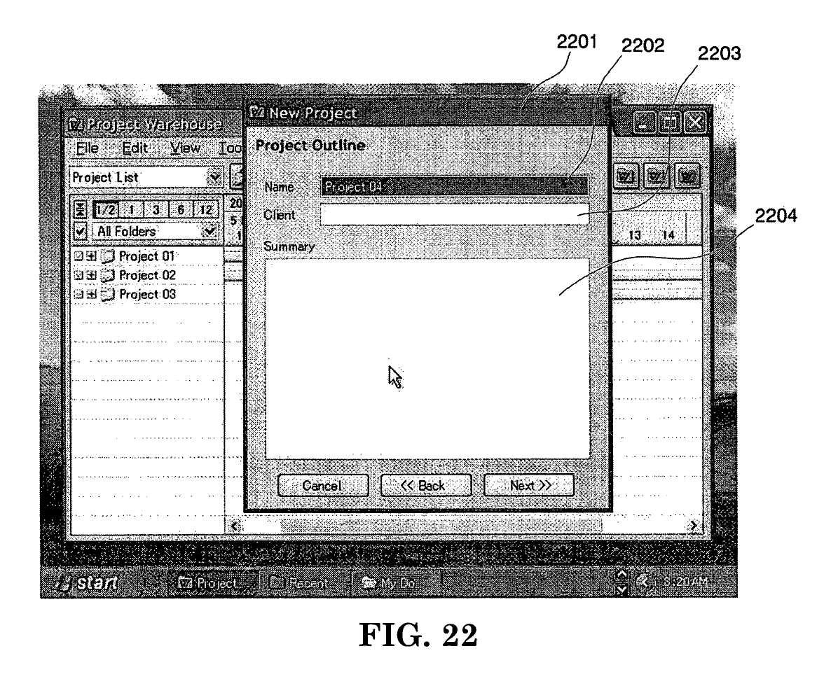

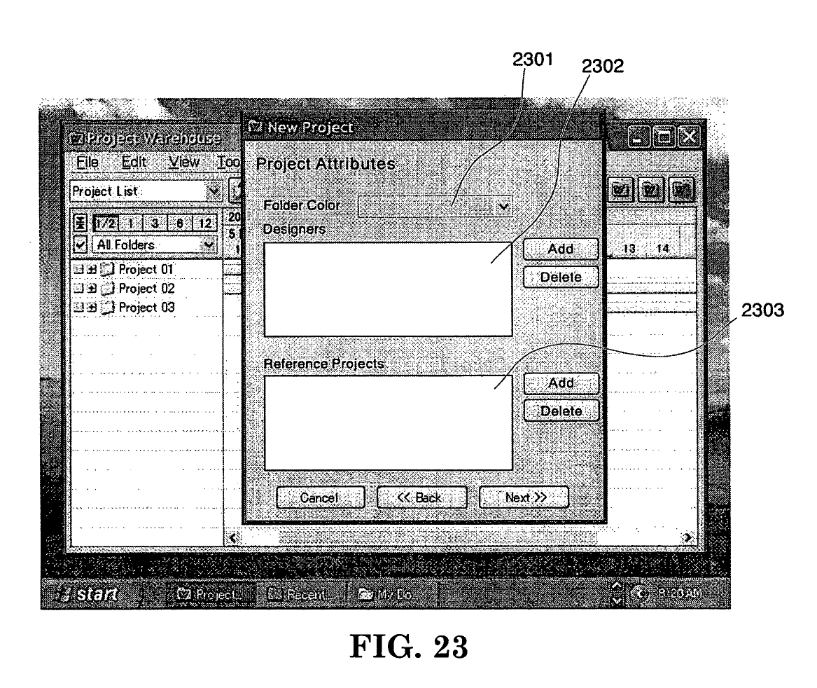

A specific method for creating a project folder is described using a project definition template. When New Project is selected from the File menu, for example, a window 2201 for creating a new project is opened as shown in FIG. 22. The project name 2202, client name 2203, and project summary 2204 are entered here and the next button is clicked to proceed to the next screen. The folder color 2301, the name 2302 of the responsible designer, and related projects 2303 are entered in the project attributes window (FIG. 23).

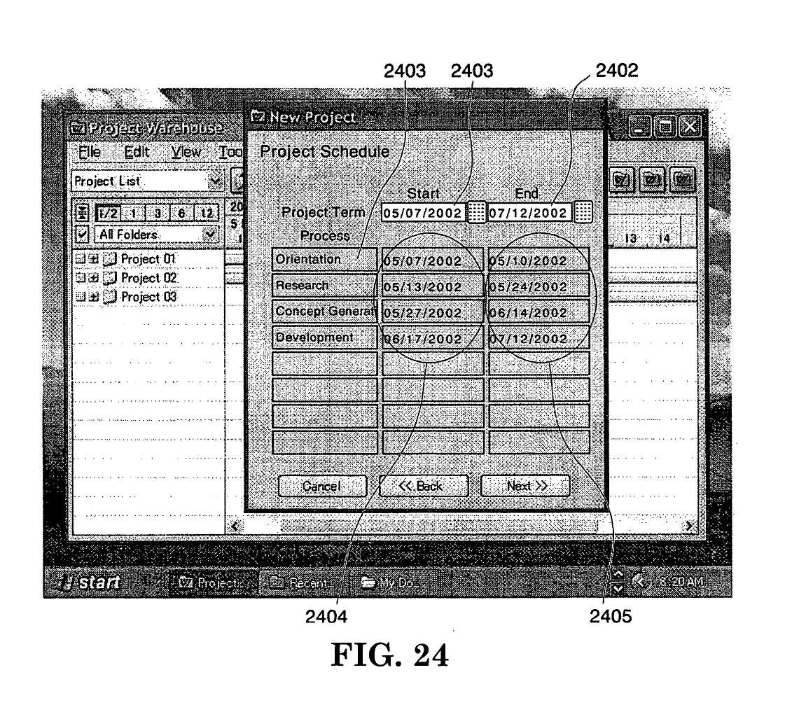

The project schedule together with the project processes and process schedules are then entered at the next screen (FIG. 24). More specifically, the project start date 2403 and end date 2402, the processes 2403 included in the project and the respective process start dates 2404 and end dates 2405 are entered. These processes are created as subfolders of the created project. In this example four processes, i.e., Orientation, Research, Concept Generation, and Development, are created and the respective start and end dates are entered as shown in FIG. 24. This information is required by the project definition template of the present embodiment, but it will be obvious that other information, such as budget information and end product, could also be required as appropriate.

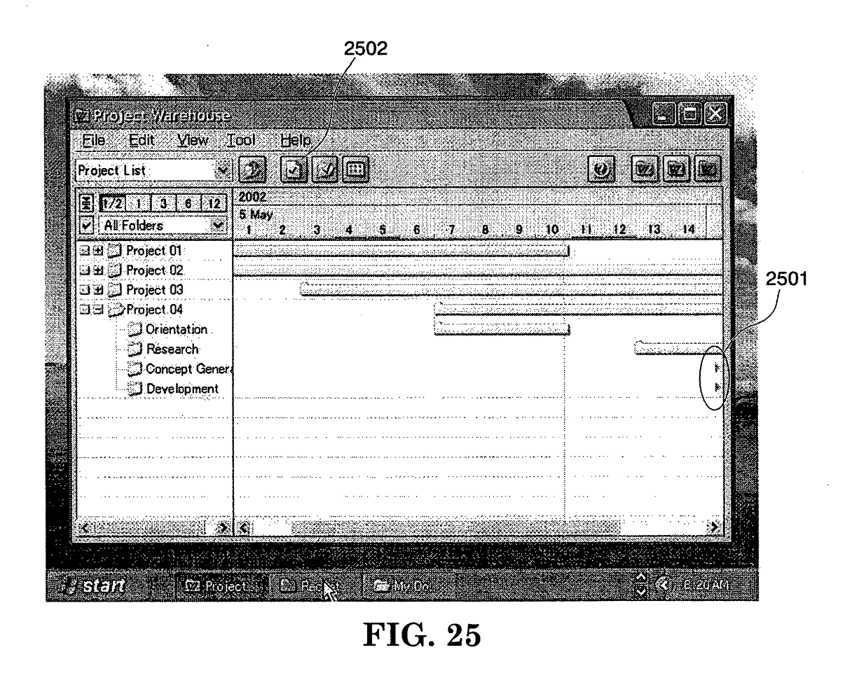

The new project thus created is shown as Project 04 in FIG. 25. Four subfolders, Orientation, Research, Concept Generation, and Development, are also created for the named processes created as described above and displayed along the time line based on the corresponding start and end date parameters. As with the triangles 1701 described in FIG. 17, triangles 2501 displayed at the right side of the window indicate that Project 04 includes future Concept Generation and Development processes (subfolders) that are beyond the scope of the displayed time line.

The settings for each folder can be confirmed and changed as needed by clicking the Property button 2502. If another folder is needed at a level below an existing folder, the new folder can also be created as part of a specific project in the main project screen.

An input method using a project definition template is described above with reference to FIG. 22 to FIG. 25, but it is also possible to restrict creating new projects to the main screen. It is also possible to use software wizards to create new projects. In this case the wizard gets the required project information from the user, and subfolders can be created by selecting the appropriate Project folder and adding a subfolder directly to the Project folder.

Storing file objects to a folder is described next. A method using the Recent Filed Link tool is described first.

Recent Filed Link is an application that boots automatically when the client computer starts up and is normally resident in memory. When a new file is created and saved on the computer, Recent Filed Link also stores an internal shortcut to the same file. It normally runs in the background and is therefore not displayed, but can be displayed from the task tray or task bar at the bottom of the Windows (R) screen.

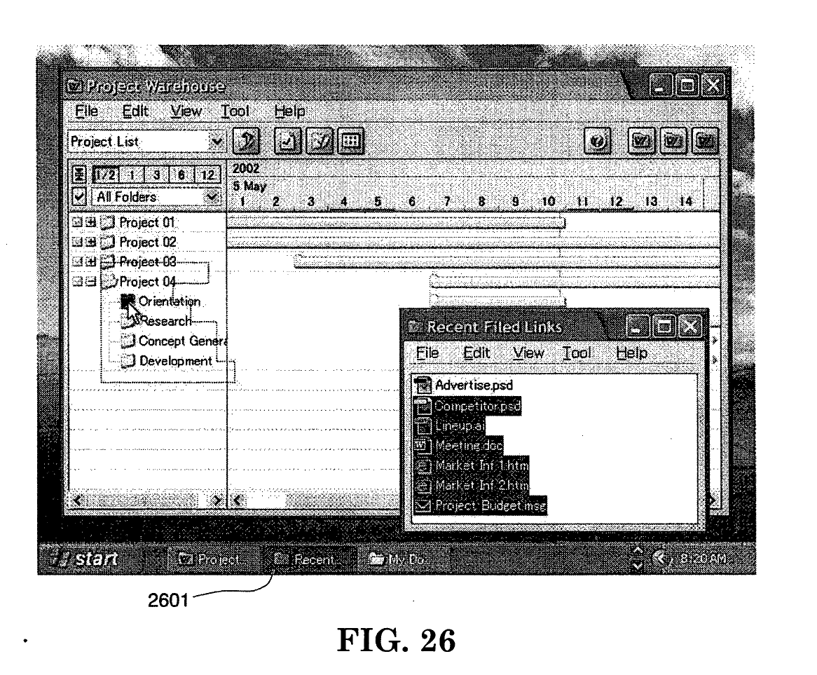

FIG. 26 shows saving an object file using Recent Filed Link. When the Recent Filed Link button 2601 is clicked, a Recent Filed Link window is opened and files linked by Recent Filed Link are displayed.

A file on the client side can be moved to a target folder on the server side by dragging and dropping the file to be moved from the Recent Filed Link window to the target folder on the server. Application-specific file formats are converted to a common standard file format on the server side at this time. For example, a PSD format file created in Adobe Photoshop (registered trademark of Adobe Systems Incorporated) is converted to JPG, and AI format files created in Adobe Illustrator (registered trademark of Adobe Systems Incorporated) are converted to PDF files. This enables even users that do not have these applications to view the files.

The moved files are located in the folder along the time line of the folder based on the time stamp of each file. In addition to the time stamp of the file creation date on the client side, each file is also stamped with date information for when the file was saved on the server, and files are located on the folder time line based on this server time stamp. For example, if a file created yesterday is stored to the server today, the icon is placed at today's date on the time line.

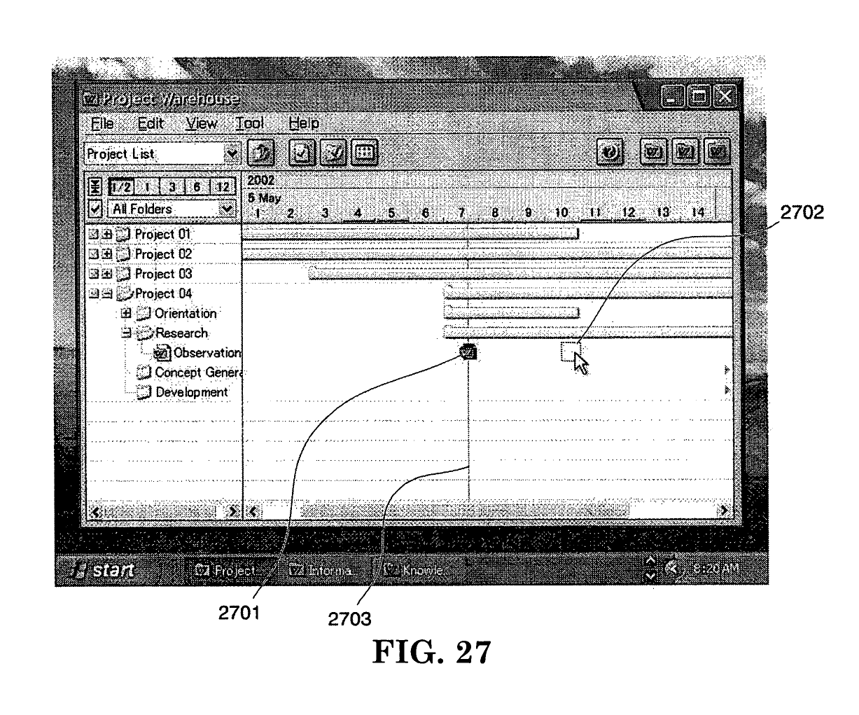

The user can change the server time stamp freely. Assume, for example, that a there is an Observation file 2701 in the Research folder of Project 04 as shown in FIG. 27. As described above, this Observation file 2701 is placed at May 7, the date this file was saved on the server, according to the server-side time stamp. That the date was May 7 is known from the date line 2703 described above. In order to change the file registration date to May 10, the user can simply drag the file icon with a mouse to that date 2702.

If the file is moved to a date outside the range of the predefined time line of the folder, the time line of the folder in which the file object is stored (managed) is automatically extended so cover the dates of the file. Conversely, if the time span of the folder is shortened, the display is automatically updated so that all files in the folder are displayed according to the time line of the folder.

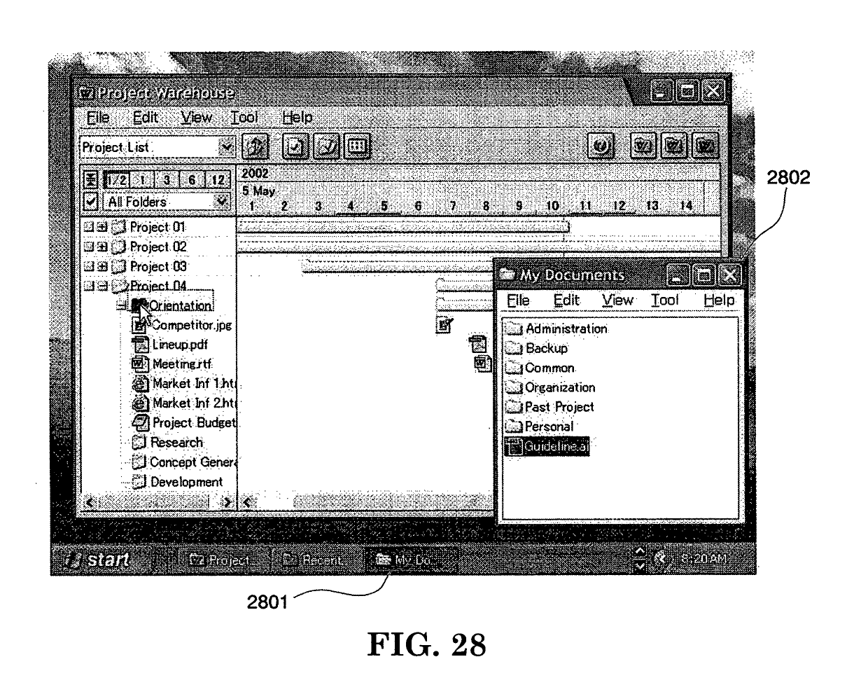

Files can also be saved directly from the desktop. For example, the My Documents button could be clicked to paste from the My Document file to the target folder. When the My Documents button 2801 is clicked as shown in FIG. 28, My Documents window 2802 opens and the files stored in My Documents are displayed. As with Recent Filed Link, client-side files can then be moved to the target server-side folder by dragging and dropping the client-side file to the target folder on the server. As may be necessary, the file format is also converted as described above. The same method can be used to store messages from an e-mail application directly to the project window.

New files created by a user are typically saved in a folder using a method such as described above. It is also possible, however, to repurpose files from a similar past project. Corporations quite frequently and effectively recycle files and documents from previous projects in whole or in part for use on a completely different project. This is further described below.

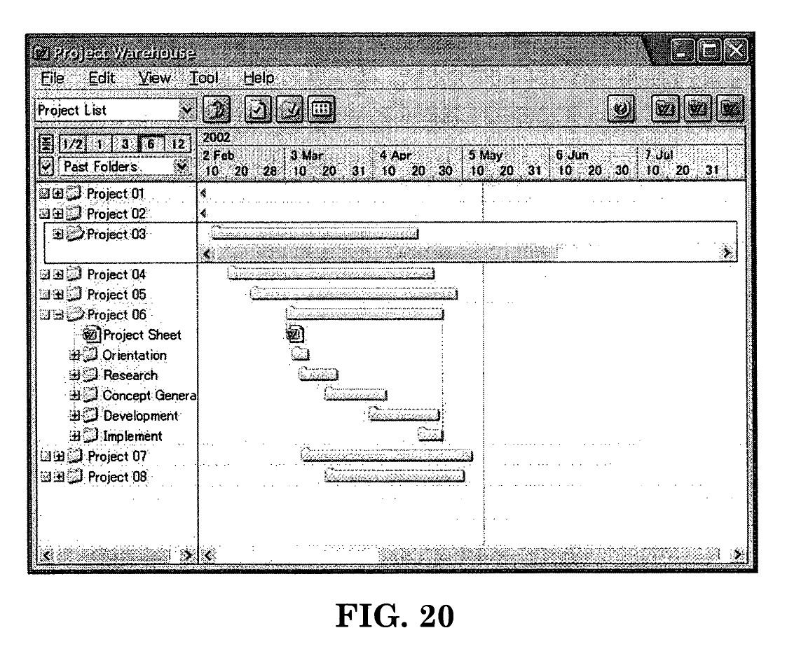

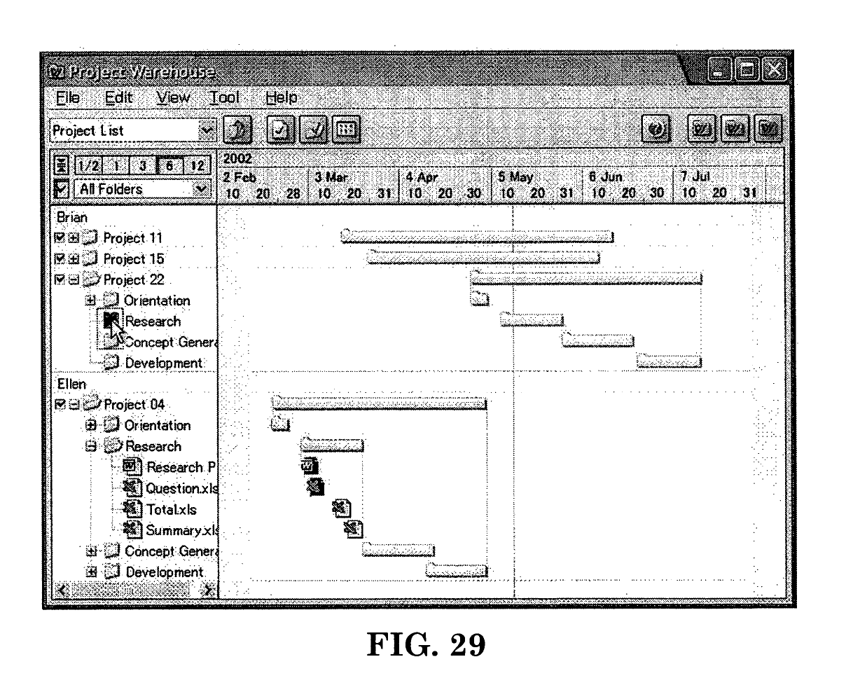

Assume that Project 22, a currently active project, and Project 04, a separate project for which documents from Project 22 are to be used, have been selected and displayed as shown in FIG. 29. It may be possible to display both projects on the same time line. If there is a significant time difference between the projects, however, the window can be split into separate panes with time lines appropriate to the respective projects so that both projects can be viewed together. (See FIG. 20 above.)

FIG. 29 shows an example in which the Research Product file and Question file stored in the Research folder of Ellen's Project 04 folder are dragged and dropped on the Research folder in Brian's Project 22 folder to copy the Research Product file and Question file to the desired target folder.

When files are thus reused, it is often only the important files that are repeatedly reused. It is therefore also useful to log who originally created the copied file for what purpose, as well as the number of times the file is viewed or copied. This file history can be used as a guide to the importance of a particular file and in the job evaluation of the original author.

Time Management

When file objects, which are the work product, are managed by theme using folders with an embedded time axis, time management is also very important. Our invention therefore also provides effective time management tools.

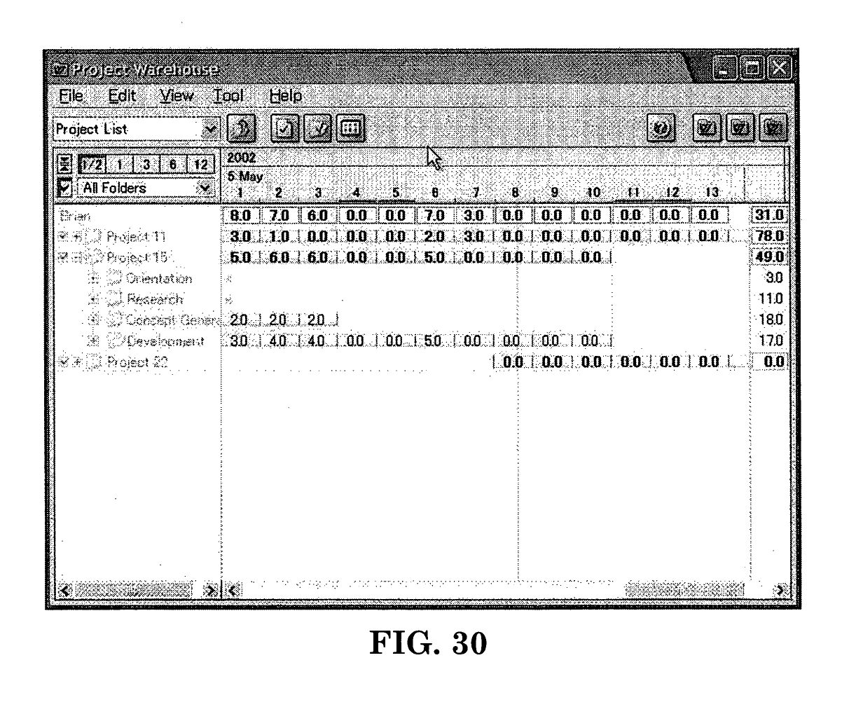

FIG. 30 shows a time management input screen. This data entry screen transparent layer presented over the current project display screen so that information related to the project or process is overlaid to the project or process.

FIG. 30 shows three projects managed by Brian and the amount of time spent on each project. By overlaying the time spent directly over the related projects and processes, it is known that a total 7 hours was spent on May 6, including 2 hours spent on Project 11 and 5 hours on the Development part of Project 15. The top row shows the total time spent on a particular day, and the right column shows the total time spent on each project or process.

This enables the user to easily know from a single table how much time has been spent each day on what tasks. How much time has been spent on each project can also be known by selecting all projects to which the user is related and displaying the hours consumed for each project.

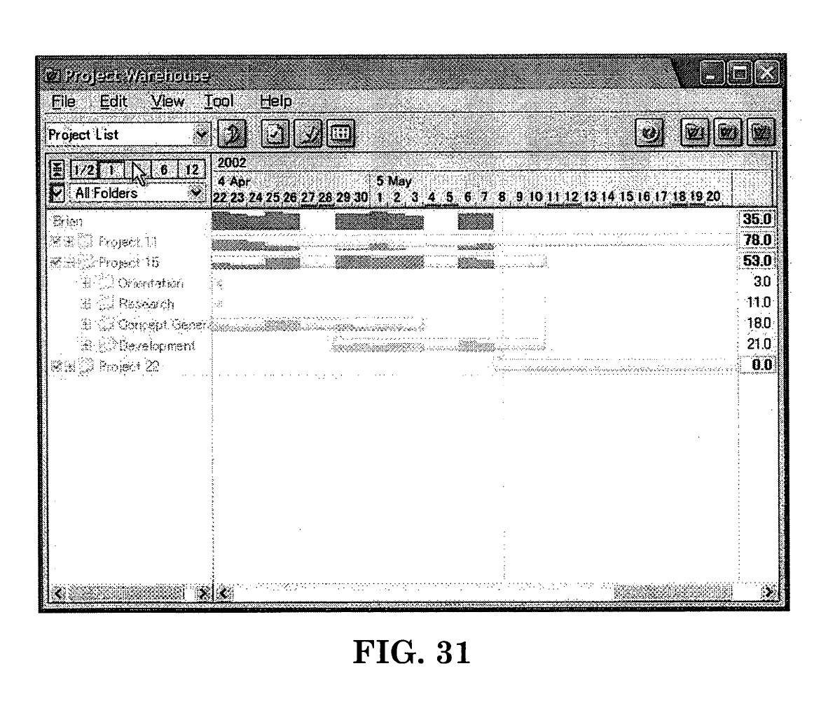

If Graph is selected instead of the consumed hours, the hours consumed are displayed with a bar graph as shown in FIG. 31, thereby presenting the same time information more visually. This function provides the general project manager with an extremely useful management tool for determining, for example, the work load (i.e., time requirement) on each project manager and the time allocation for each step of the project. Furthermore, because the time required for the project and the resulting cost can also be calculated, this information can be reused as reference material the next time a similar project comes up.

Printing and Projection

Projects created as described above can be printed in various ways. Some typical examples are described below.

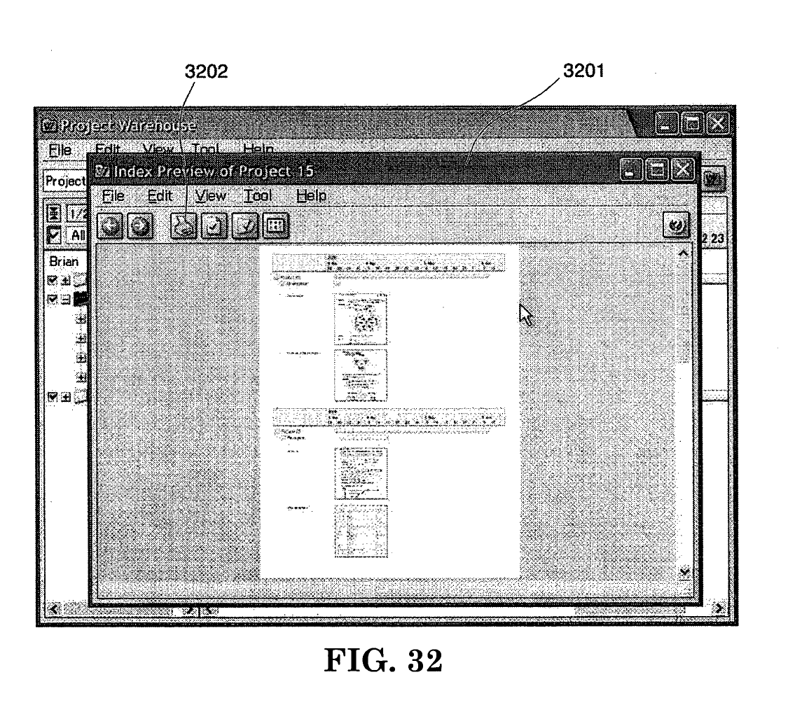

One method is to print an index of a selected folder. This index contains a thumbnail sketch of all files contained in a folder as shown in the print preview in FIG. 32. The thumbnail sketches are printed in chronological sequence and the time line is also printed so that the file dates are also known. When the folders to print are selected, the contextual menu displayed, and print index is selected, a print preview 3201 is displayed so that the file objects contained in the selected folder can be previewed. When print is selected an index to the content of the selected folders is printed. The print button 3202 at the top of the window can also be pressed to print the previewed index.

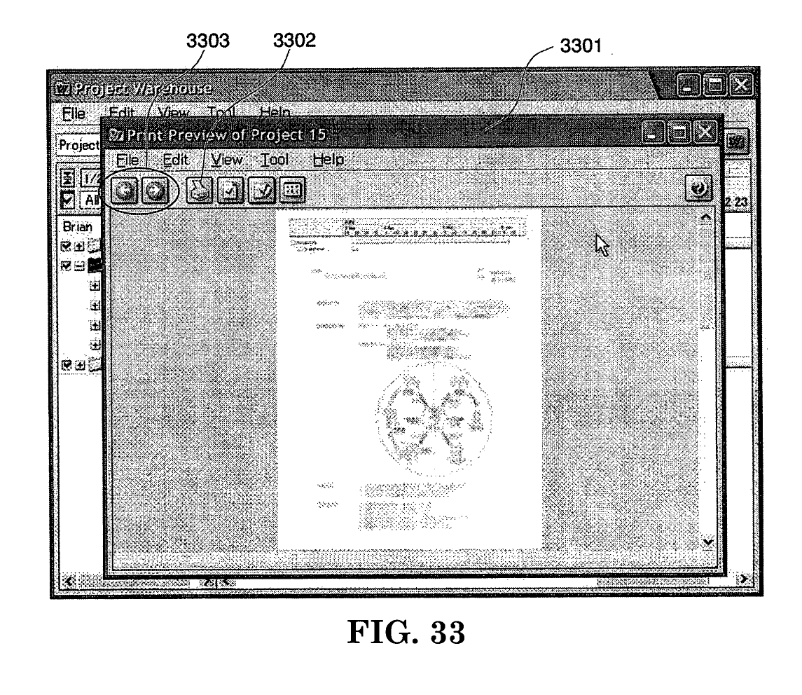

The directory of files and folders contained in a selected folder can also be printed using the “directory print” function as shown in FIG. 33. This directory print feature prints each of the files in the folder as a single continuous print job. A time line is also printed so that the file date information can also be known. As with the print index feature described above, the desired folders are first selected and the contextual menu called to select “print directory.” Print and preview menus are then displayed. Selecting preview causes the preview window 3301 to open, showing all objects in the selected folder. If print is selected, the directory is printed. The directory can also be printed from the preview window by clicking the print button. To view all of the files before printing, the navigation buttons displayed at the top left of the window can be used to sequentially review all file objects.

These examples describe selecting the folders to print and then printing from a contextual menu, but it will also be obvious that the folders could be printed from a menu bar selection.

Furthermore, instead of printing the selected files to paper, a sequence of files saved in a particular project could also be projected onto a screen using a projector. A time line is also preferably projected in this case so that the file date information can also be known.

Shared Information Screen

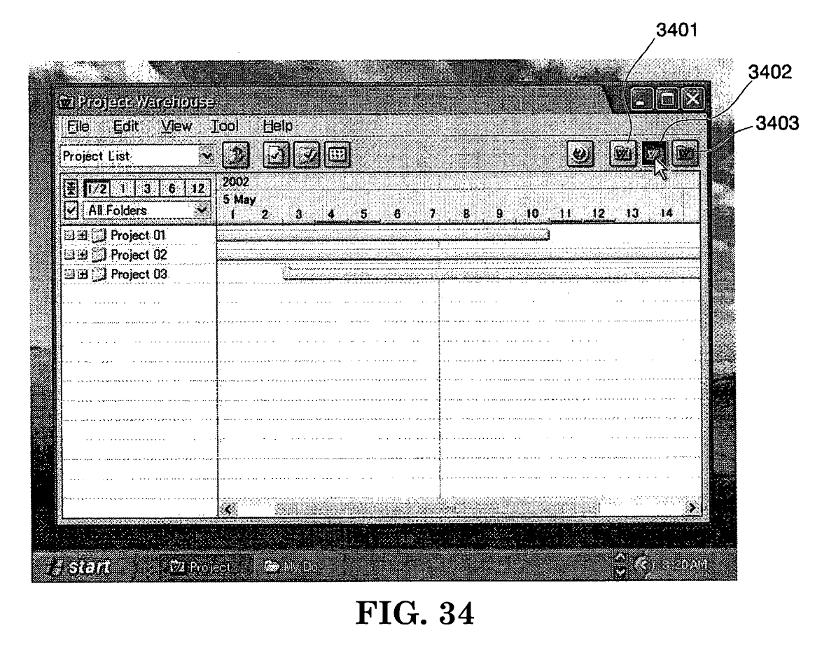

While operations in the shared information screen are the same as described with reference to the project screen above, operations particular to the shared information screen are described briefly below with reference to FIG. 34 to FIG. 37.

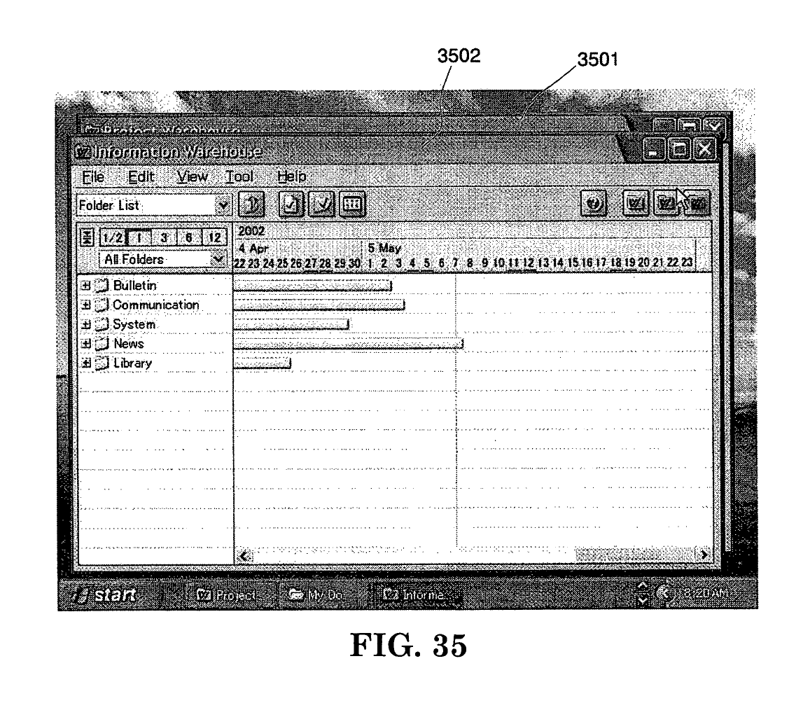

FIG. 34 shows project screen 311. The main screen display buttons, i.e., project screen display button 3401, shared information screen display button 3402, and knowledge screen display button 3403, provided at the right side of the tool bar can be used to move from project screen 311 to shared information screen 310 or knowledge screen 312. When the project screen 311 is displayed as shown in FIG. 34 and the shared information screen display button 3402 is clicked, the shared information screen 3502 is displayed on top of the project screen 3501 as shown in FIG. 35.

Using a different color for the title bar of the project screen and the shared information screen makes it possible to easily determine by color which screen is currently active. To view saved files in the shared information screen, the folders to be viewed are selected using the same operation used in the project screen. The selected objects are then displayed in a separate window.

New information can be added in the shared information screen 310 by selecting File-New-template from the menu bar.

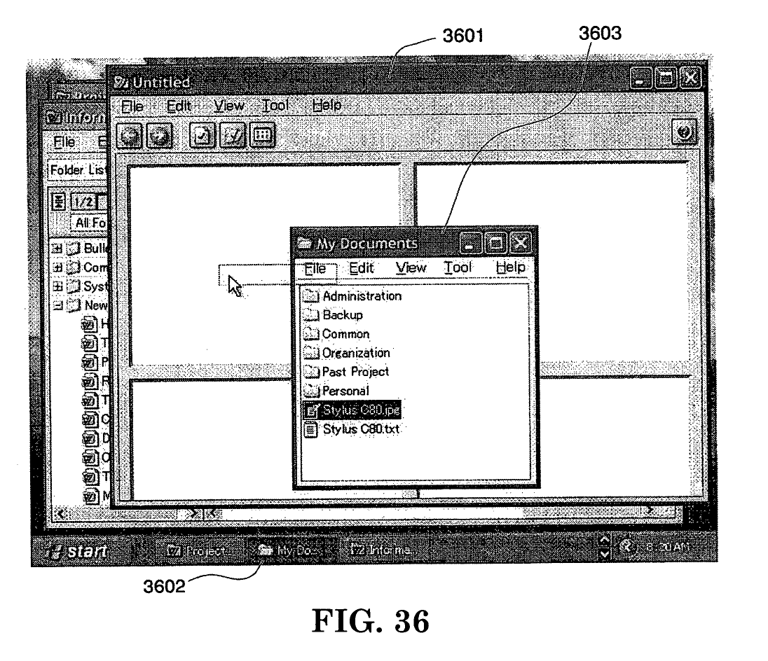

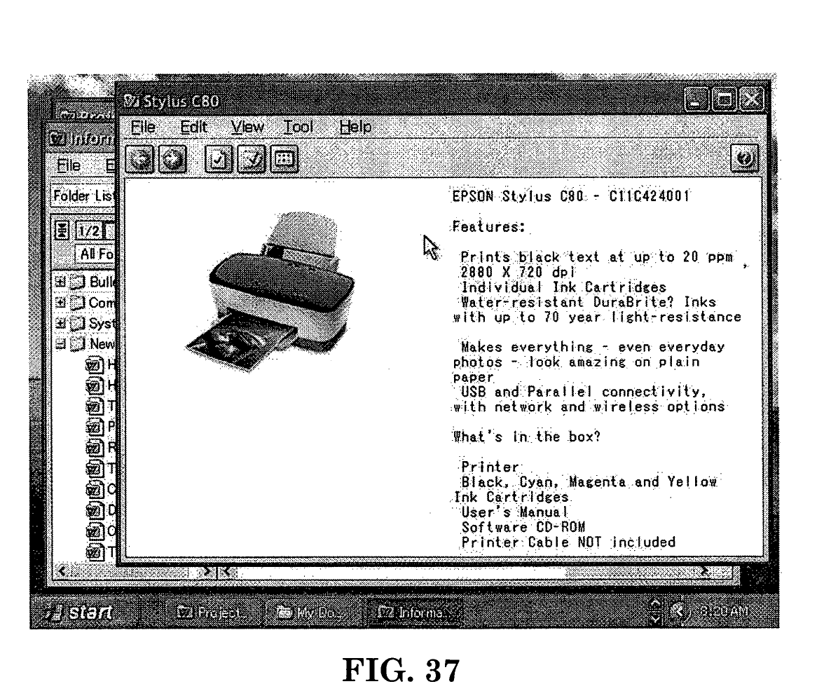

Four templates are provided in this embodiment according to the different types of files, specifically, “text,” “image,” “text+image,” and “HTML.” For example, if “text+image” is selected, a data entry screen 3601 as shown in FIG. 36 is displayed. If the My Documents button 3602 is clicked, the My Documents window 3603 is opened and the files stored in the My Documents folder are displayed. The image file StylusC80.jpg and the text file StylusC80.txt are then selected from the My Documents window, and the image file and text description are respectively pasted and saved in the desired areas in data entry screen 3601. When saving the file it is, of course, desirable to assign a name enabling object content to be known without specifically opening the file. If the saved file is then selected, it can be confirmed as a file having appropriately placed image and text as shown in FIG. 37.

Transmitting Search Strings

A search string can be transmitted for moving between information related to the main screens to, for example, display related knowledge from the project screen 311 or shared information such as related news from the knowledge screen 312.

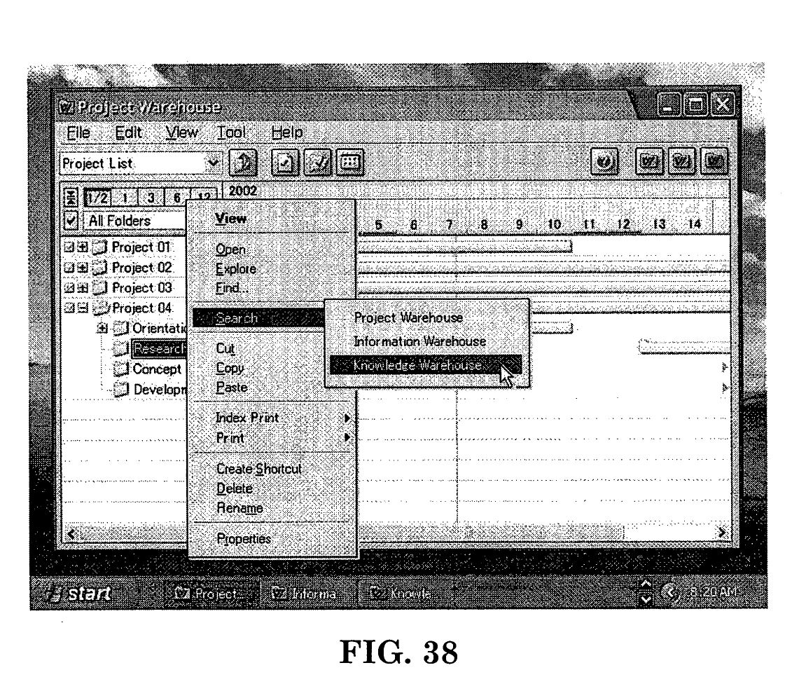

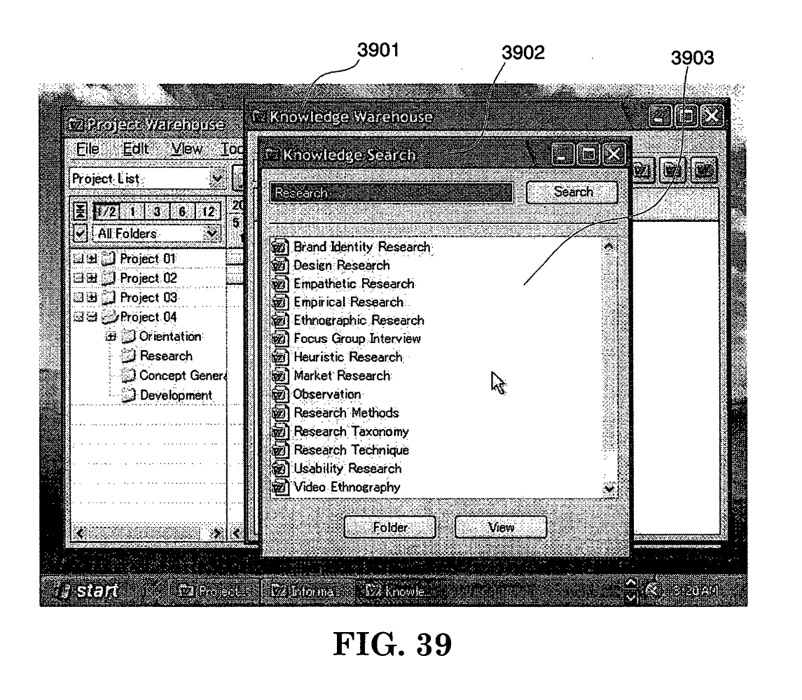

FIG. 38 and FIG. 39 show sending a search string from the project screen to the knowledge screen. It is assumed that while viewing the project screen in FIG. 38 the user wants to search for knowledge related to the keyword “Research.”

In this case the word “Research” is selected and then “Project Warehouse,” “Information Warehouse,” or “Knowledge Warehouse” is selected under “Search” from a contextual menu. If “Knowledge Warehouse” is then selected the knowledge screen 3901 is automatically activated and the Knowledge Search window 3902 is displayed as shown in FIG. 39, the word “Research” selected in the project screen is sent automatically to the Knowledge Search window 3902 as the search word, a search is run, and the results are listed in window 3903.

In other words, by simply selecting a keyword to search on in the project screen and specifying the search object (i.e., which of the directories to search), the character string is sent as the search string to the selected main screen (the knowledge screen in which example), and the related information is automatically listed. This search function makes it simple to find and move to related files in a different main screen.

Saving Shared Information and Knowledge in a Project

In addition to creating and viewing files and objects, the project screen 311 also enables files and objects to be reused so that users and organizations can learn from past projects and benefit from experience. In addition to learning from files created by others, users can also learn from information stored in the shared information database and knowledgebase.

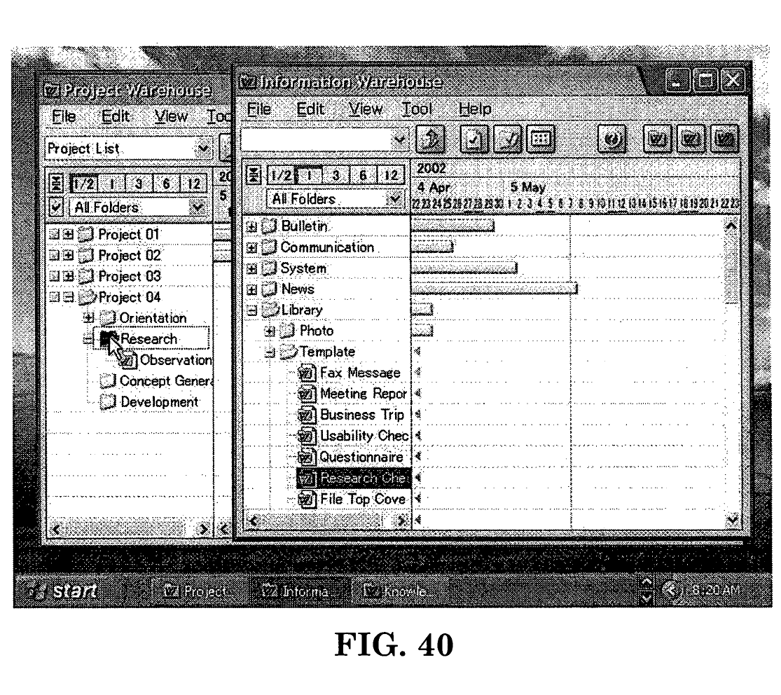

The present invention facilitates such learning by enabling information stored in the shared information screen 310 to be copied to a project screen as shown in FIG. 40. In the example shown in FIG. 40 templates of necessary files are being copied from a data library (the Information Warehouse) shared by the members to another project. The copied template files are then repurposed for the current project by simply editing the necessary parts.

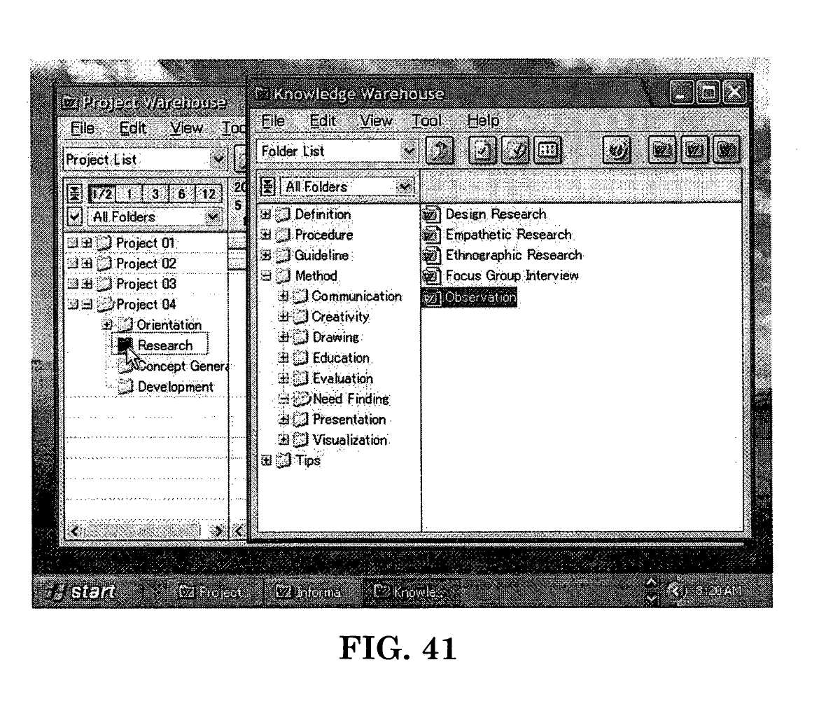

FIG. 41 likewise shows an example of copying information from the knowledge screen to the project screen. The method called “Observation” is learned and the used knowledge is stored as a project event.

It is thus possible to store to the project screen everything experienced, gained, and used in the project, including files created as part of the project, reused files, referenced data, referenced URLs, e-mail messages used for communication, what data libraries were used, and learned knowledge. Another user can thereby experience in a short time exactly the same events experienced by a first person, and that experience can be used to seek even better performance.

Merging Plural Files

Individual files can be saved and reused as project events as described above. The directory management method of our invention also makes it possible to create links between multiple files so that the multiple files can be handled as a single event (project experience).

Conventional computer systems with a GUI represent a single file with a single icon. A single file usually cannot contain all of the information related to a single project, and multiple files and even multiple applications are typically used. A directory is a file system object for managing multiple files and multiple applications in a single group. With conventional directory management methods, however, multiple files managed in a given directory simply share part of a common file path, and opening multiple related files requires separately opening and starting each of the files and applications.

For example, the description for some file A and advice from another person might be saved and managed in a separate file B, and this file B might be created in a different application. The relationship between these related files, A and B, is gradually lost over time, however, and a different viewer might not be able to understand the relationship between the two files.

This invention solves this problem by virtually merging the multiple files.

More specifically, the multiple linked files are grouped using a group icon which can then be clicked to automatically open, edit, and display the multiple files and applications in the group. Files can be linked by, for example, dragging and dropping a child file on a parent file.

When this group icon is moved or copied, for example, the entire group of objects is moved or copied. When the group icon is opened, the multiple files in the group are automatically opened. If the files in the group were created with different applications, each of those applications is also started. If the files were created with the same application, the files are opened with that application and displayed in separate windows. Individual files in the group can also be opened using a contextual menu, for example, rather than opening all files.

By thus virtually linking separate files with a particularly strong correlation between the file content, the separate files can be treated as a single file, thereby reinforcing the relationship between the files.

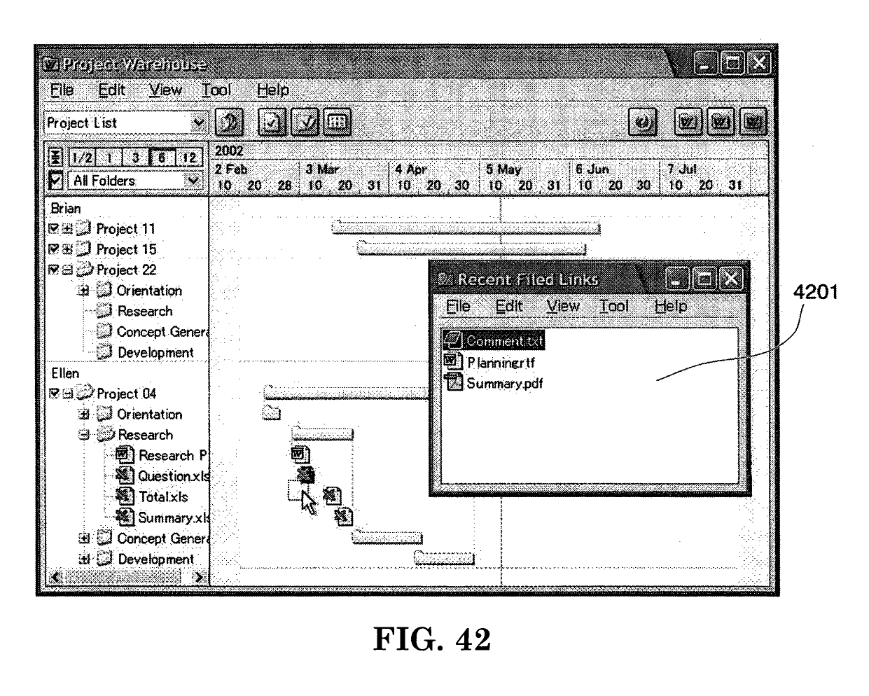

FIG. 42 shows an example of linking a “Comment” file containing comments about a “Question” file to the “Question” file already stored in the Research process of Project 04. The “Comment” file is first displayed using Recent Filed Links (4201). When the Comment file icon is dragged and dropped on the “Question” file of Project 04 to which a link is desired, a contextual menu is displayed.

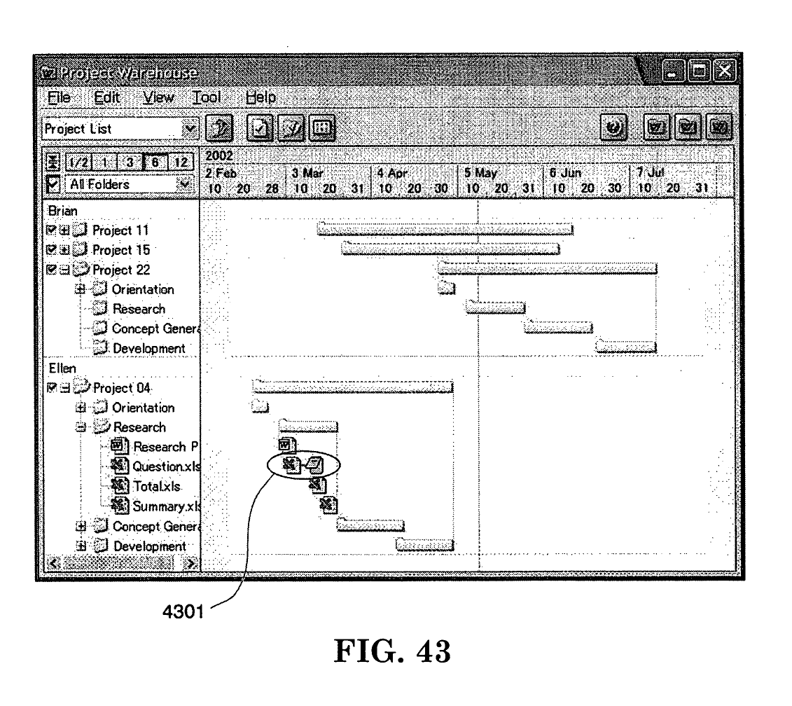

If “merge icons” is selected from the displayed contextual menu, the “Question” file icon and the “Comment” file icon are displayed linked by a line (4301) as shown in FIG. 43. More specifically, files are linked by storing a link between the multiple objects of a particular cell in the directory matrix, and the icons representing the linked objects are displayed with a visual link joining the icons into a group icon.

Merging is not limited to two icons, and other icons can be dropped on top of this icon to merge three, four, or more icons. To break a link between objects a “break link” item could be selected from a contextual menu, for example. This results in the linked files being stored as separate individual files. Normal file operations, such as delete and copy, can also be performed on linked files.

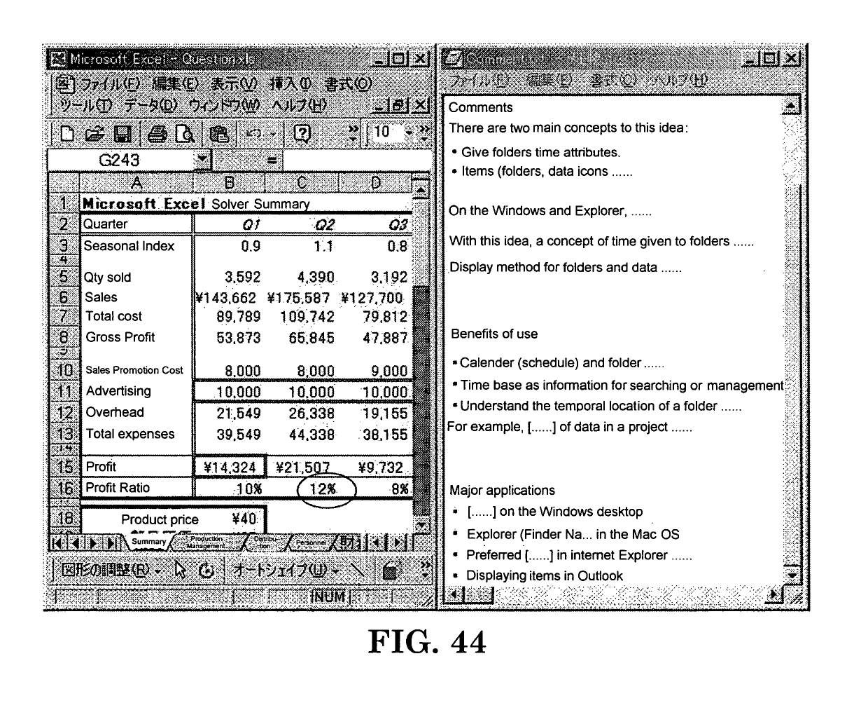

When a group icon is opened the multiple linked files are simultaneously opened as shown in FIG. 44. In other words, when a command to open the multiple objects displayed with a single group icon is received, the multiple objects are opened and presented based on this single command.

In this example files created with different applications are opened at the same time by asserting an open command to each of the respective applications, but files created by the same application are opened as separate files by the same application. The user can therefore view multiple related files at the same time because the files are automatically opened in response to a single command.

By linking a file containing descriptive text to a particular image file, for example, this type of file integration makes it possible to easily find a desired image even if an image search function is not available by searching the text content of the description file. This function can also be used for brainstorming over a network by, for example, using an “idea” file to accumulate ideas contributed by different team members.

The present invention adds as an extension of the concept of time described above the concept of a directory matrix for displaying file and folder objects. When it comes to managing knowledge and data libraries, how the information is grouped and categorized is more important than using the concept of time. Whether it is the user that creates and saves a file or the user that is looking for a saved file, how the files are categorized and what keywords are assigned to the files is an important consideration for directory management.

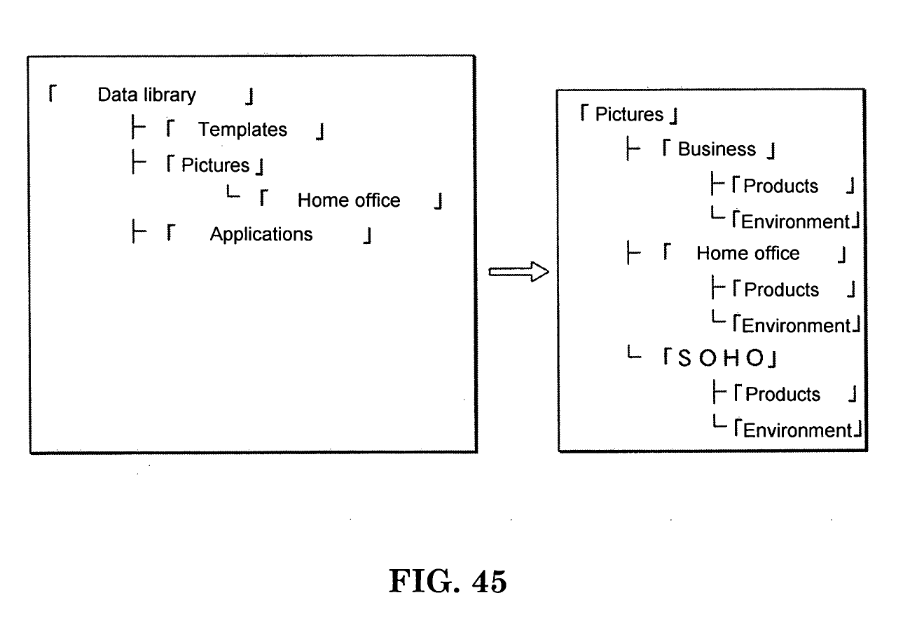

Consider an example in which the user took pictures of a home office environment and wants to file the pictures in the computer. With a conventional directory management system as shown in FIG. 45 in which there are “templates”, “pictures”, and “applications” subcategories (folders) under the root “data library” category, the user might save the home office pictures to a “home office” folder added under the “pictures” folder.

Another user with a collection of pictures of home office products might create both “products” and “environment” folders under the “home office” folder to manage pictures of those respective categories.

Yet another user might create “products” and “environment” folders in separate “home office,” “business” and “SOHO” folders. The same common concept is thus applied to different “products” and “environment” folders.

Considering the duplication of categories in this simple hierarchical system, the present invention manages files using a matrix of multiple hierarchical structures.

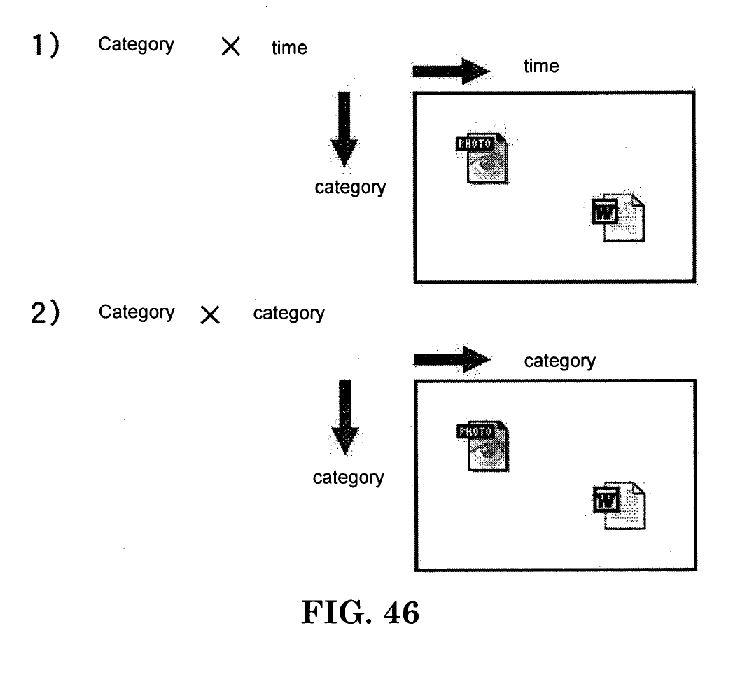

More specifically, a directory matrix is constructed from parameters defining the dimensions of the matrix. These multidimensional parameters, specifically a file management parameter and a time line parameter, are also attributes of each object managed by the directory. The objects are then displayed linked to a particular cell in the directory matrix based on the values of these parameters (attributes). Rather than simply applying multiple parameters for finding a desired file, these attributes enable the file objects to be displayed in a two-dimensional space as shown in FIG. 46.

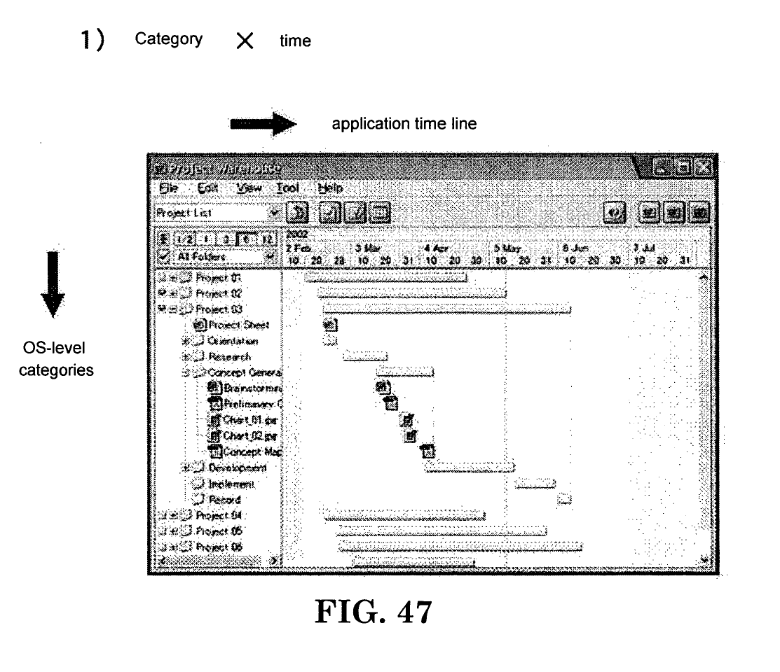

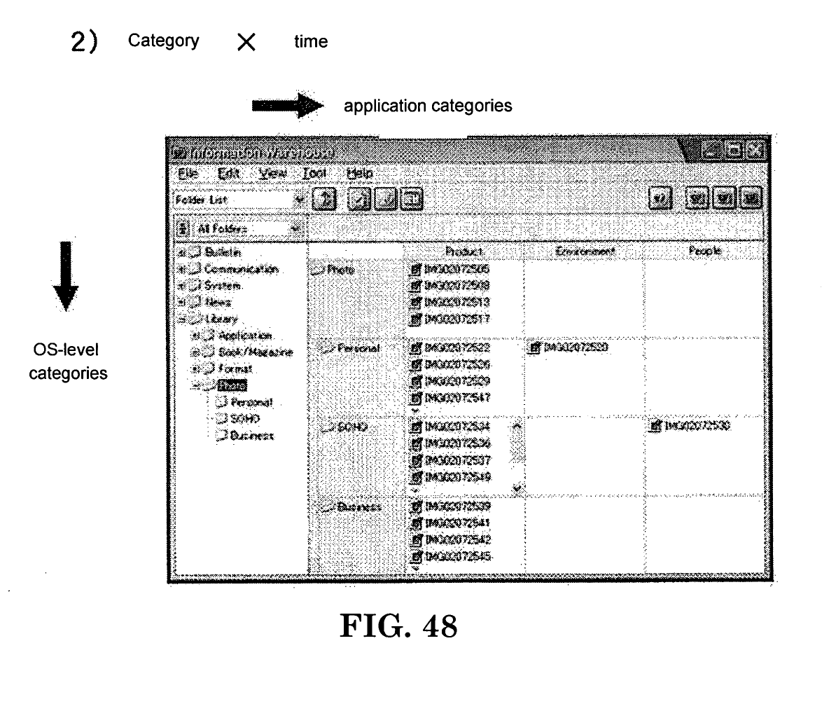

This directory matrix is a file directory constructed from a matrix of plural hierarchical structures. As shown in FIG. 47 and FIG. 48, the directory matrix of the present embodiment uses a two-dimensional file structure of

(1) category×time, and

(2) category×category

as more fully described below.

(1) Category×Time

If a directory matrix defined by the object category as the directory management parameter and time as the time line parameter is used, the directories (folders) for managing the projects are treated as aspects of the design process displayed along the category axis (y-axis) and displayed with length along the time line (x-axis) together with any objects in an expanded folder. By adding a position on the time line as a parameter separate from conventional directory management parameters (such as the filename, date, size, and format), files can be managed in a two-dimensional space defined by the object category (file structure) and time (time line).

In other words, parameters determining the multiple dimensions of a directory matrix are assigned and set for each object (folders and file icons) managed by the directory. The cells of the directory matrix are segments in the matrix grid determined by the units of these parameters, specifically a directory management parameter describing one axis of a two-dimensional matrix and a time line parameter describing the other axis of the matrix. The individual objects (folders and file icons) are then displayed linked to a specific cell of this directory matrix based on the parameter values set for each object. These cells are thus the units for displaying the objects.

(2) Category×Category

A position on the time line is used by way of example as a new directory management parameter above. Information such as stored in the data library and knowledgebase, however, is more appropriately managed with a hierarchical structure than a time-based structure. Therefore, instead of using a time line to manage such information, a parameter is added to these objects to construct a two-dimensional directory matrix defined by an OS-level file structure axis and an application-level file type axis.

In other words, the directory matrix used for such files in this embodiment of the invention is defined by the category (file name or directory path, e.g.) used as a directory management parameter at the OS level, and the category (such as a user-defined object category) used as a directory management parameter at the application level.

In this case the directory matrix is a grid segmented on both x- and y-axes by items for categorizing the files, thus defining the matrix cells. Objects are then displayed linked to the appropriate cells based on the category values defined for each object.

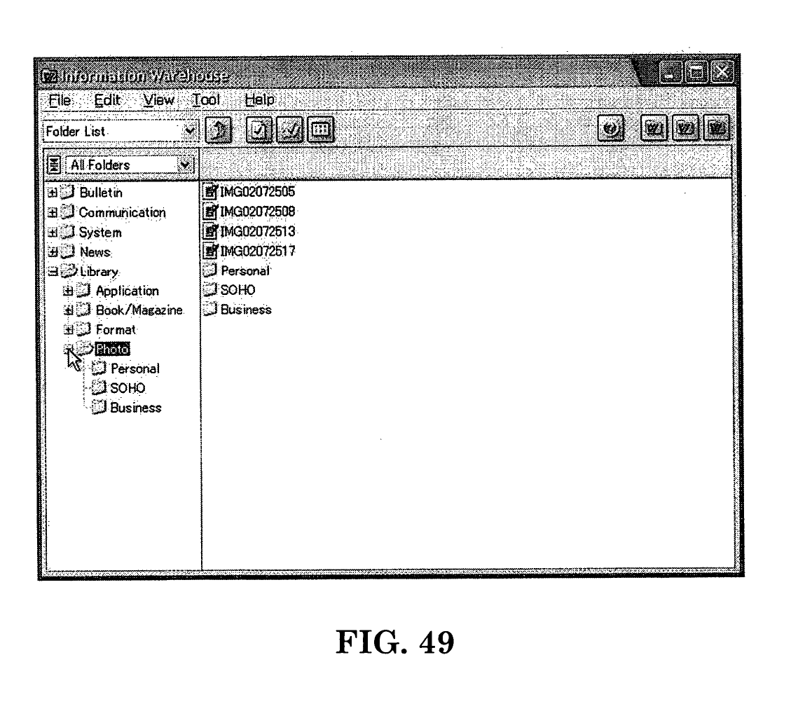

Presentation of a conventional directory management system at the OS level is shown in FIG. 49 for comparison. As shown in FIG. 49 the directory structure is shown down the left side of the window while the objects contained in a selected subdirectory are shown in the right pane of the window.

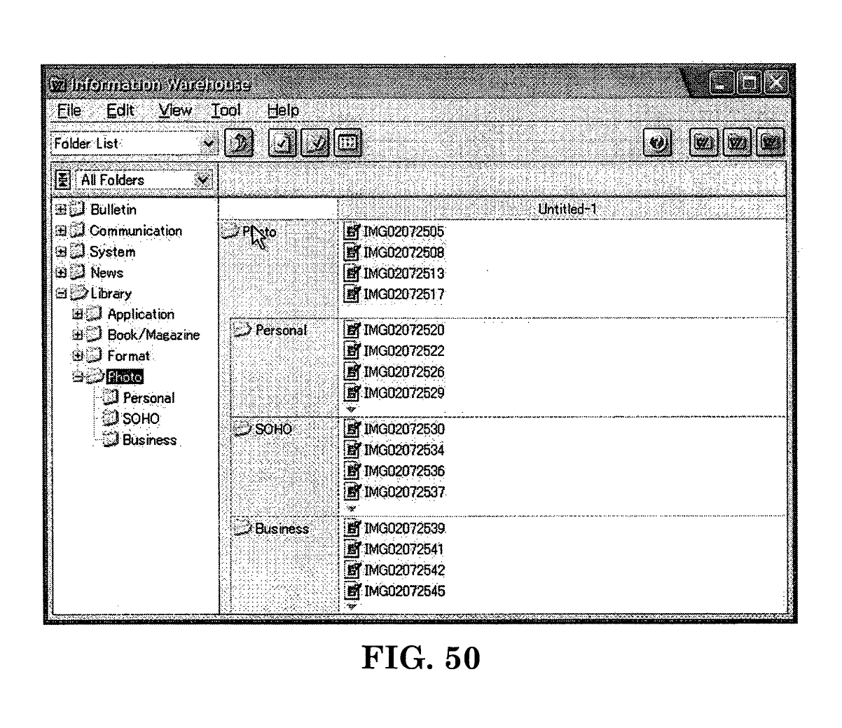

When “show matrix” is selected from a menu with the directory management method of the present invention, however, both subdirectories and files in a selected directory (folder) are displayed as shown in FIG. 50. The horizontal axis at this time is a single category. An inverted triangle denotes there are additional files that do not fit in the display.

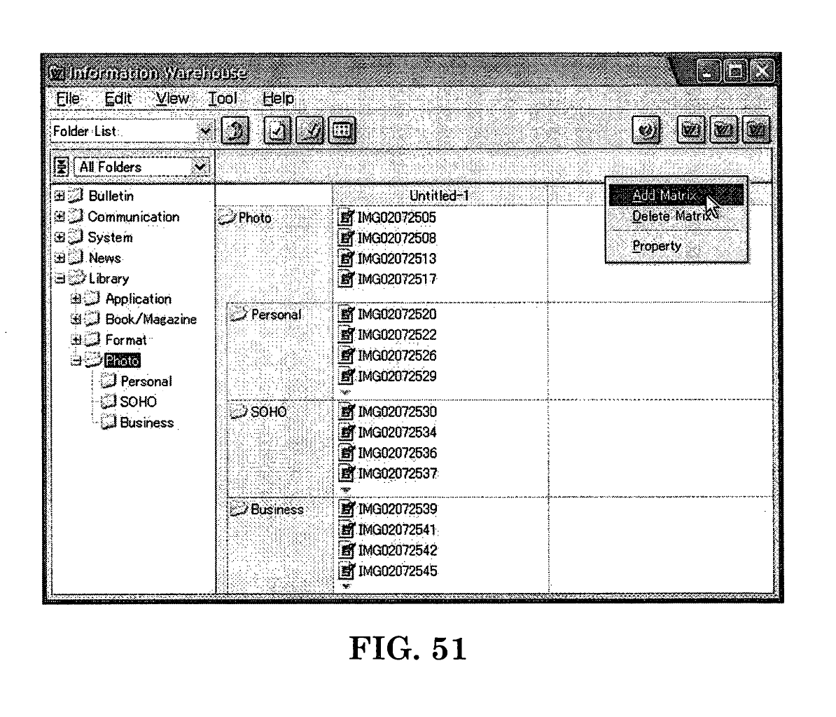

To add another category to the horizontal axis in this case, the user can select “Add Matrix” from a contextual menu as shown in FIG. 51. This adds an undefined category and a column of empty cells to the directory matrix. Categories along the horizontal axis are managed and displayed at the application level. New categories are untitled, and can be named as desired by the user.

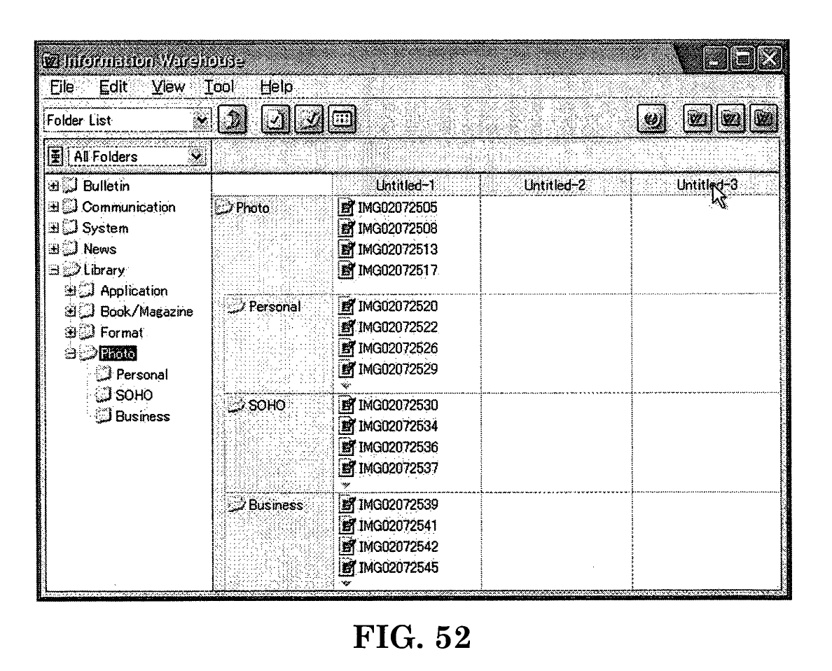

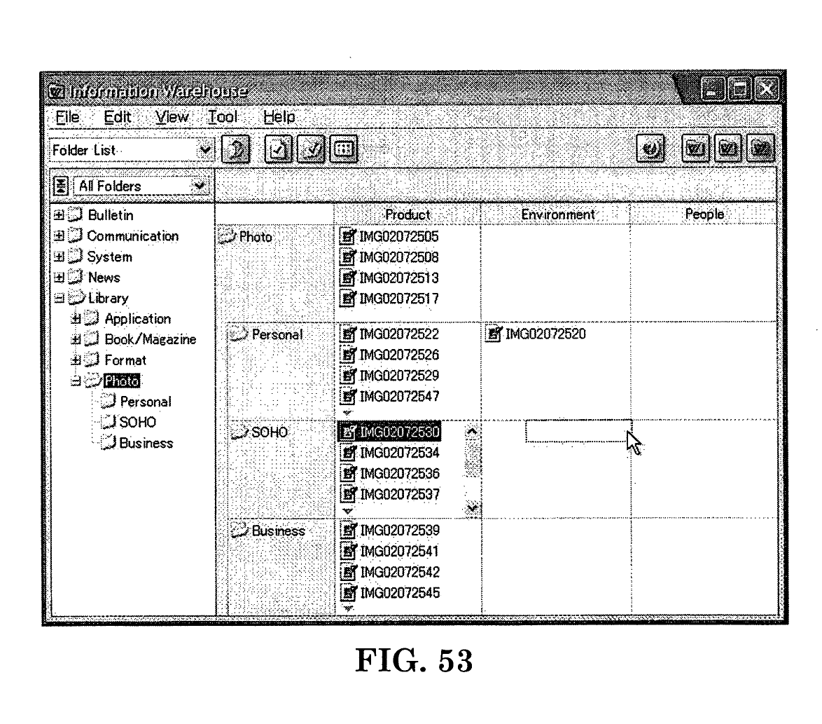

FIG. 52 and FIG. 53 show moving an object from one cell to another. If all files cannot be displayed in a selected cell, a scroll bar is displayed as shown in FIG. 53 when that cell is selected. A desired file can be moved to another cell for easier viewing by simply dragging and dropping the file object. If an object is moved horizontally to a different cell in the same subdirectory, directory management parameters stored at the OS level (i.e., the directory management parameters (such as filename and directory path) assigned to the vertical axis) are not changed. However, the directory management parameter used at the application level (i.e., directory management parameters assigned to the horizontal axis, such as the category name) is updated to the directory management information assigned to the cell on which the object is dropped when an object is moved to a different cell.

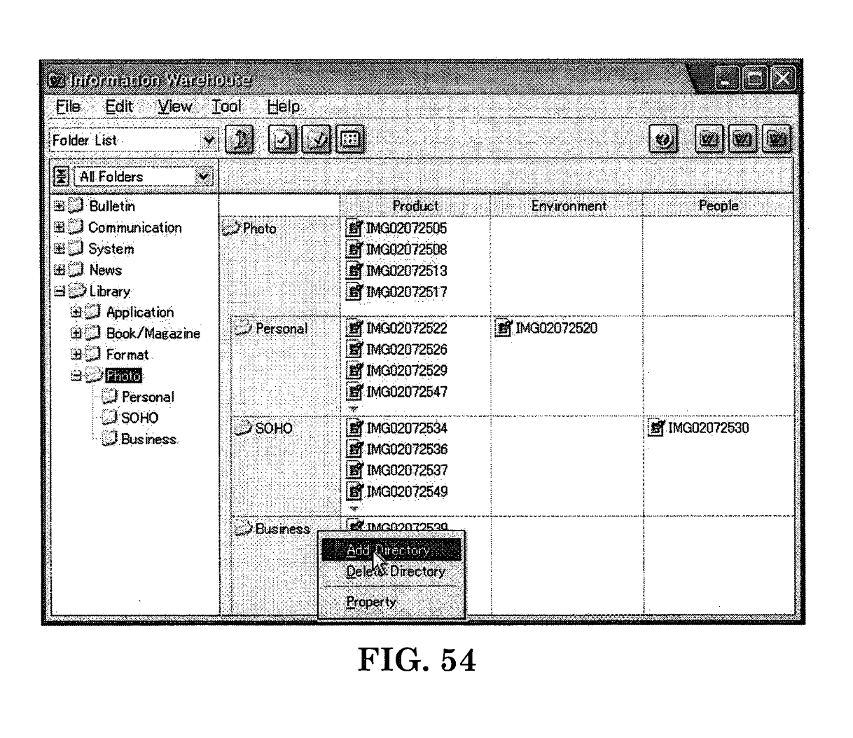

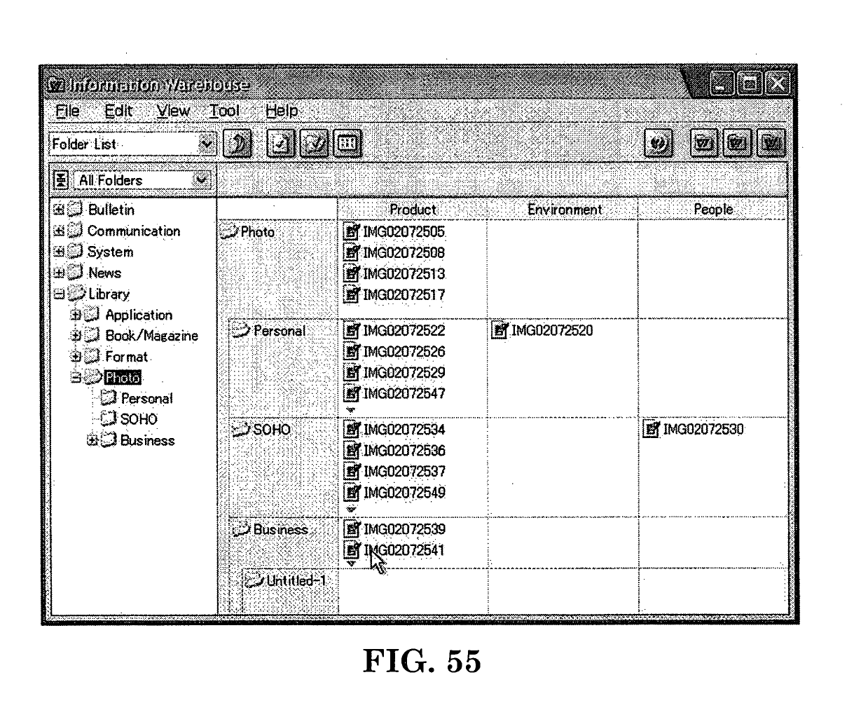

FIG. 54 shows adding another subdirectory to the vertical axis by selecting “Add Directory” from a contextual menu, for example. When a new subdirectory is added to the matrix, an empty category and empty cells are added as entries to the parent directory and displayed as additional cells as shown in FIG. 55. When the directory matrix is enlarged along the vertical axis, the OS-level directory management information is also updated.

This embodiment of the invention has been described using the OS-level directory management information as a file management parameter by way of example, and it will be obvious that the invention shall not be so limited. The directory matrix could, for example, be constructed using a user-defined file management parameter and a time line parameter.

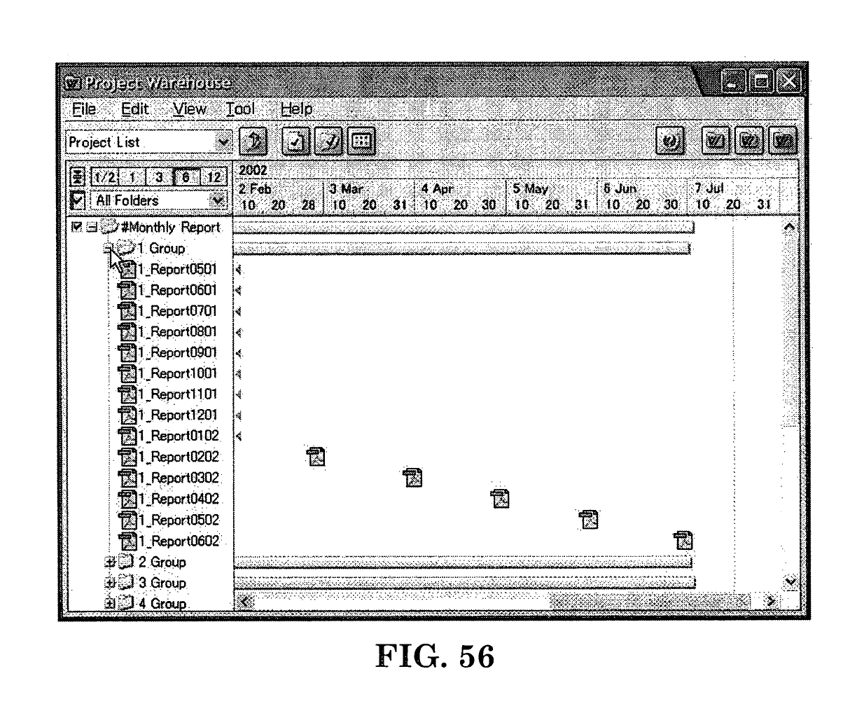

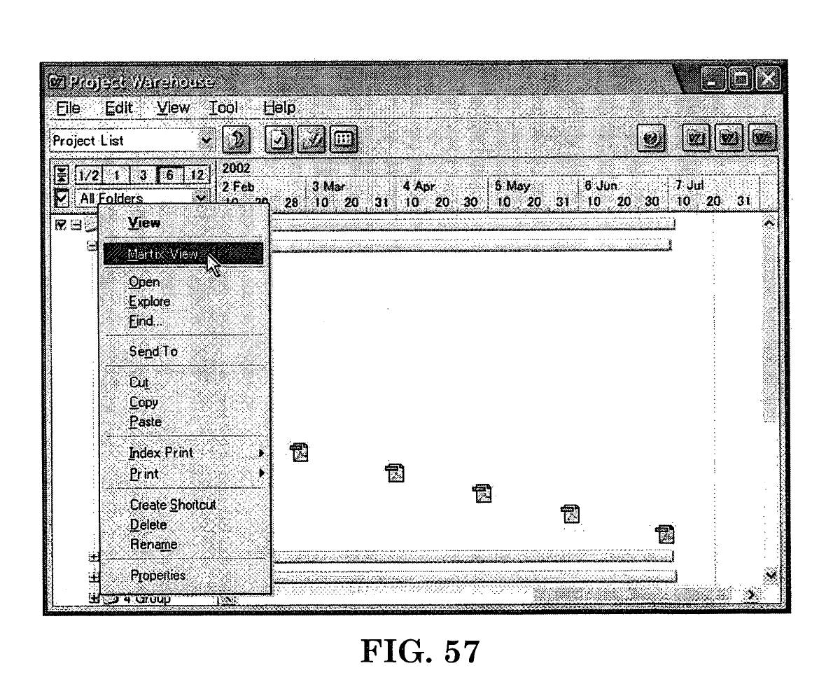

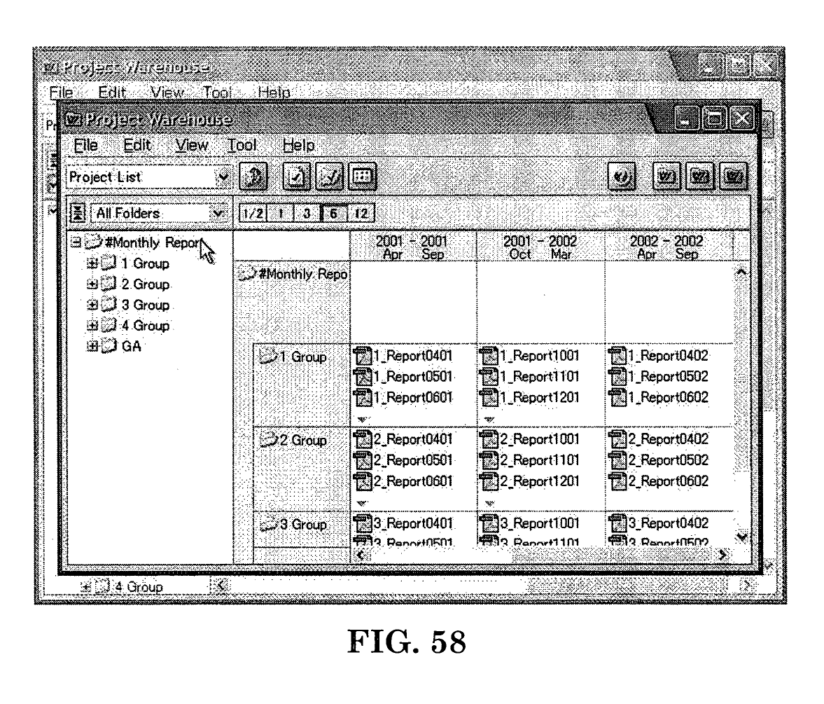

The time line itself could also be used as the user-defined file management parameter. That is, as shown in FIG. 56, when the time line is displayed on the horizontal axis, a specific directory is selected, and “Matrix View” is selected from a contextual menu, for example, as shown in FIG. 57, subdirectories and files in the selected directory are displayed in a matrix in a different window (see FIG. 58).

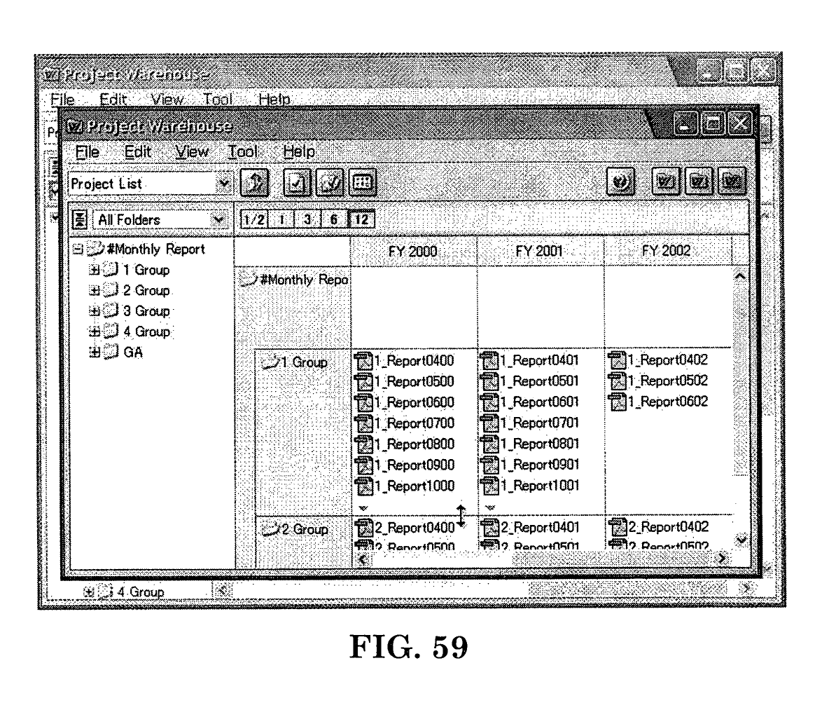

If the horizontal time line defined by default is in 6-month units, the horizontal axis of the subdirectory matrix is also built from the same 6-month units based on the default setting for the time line. The number of cells displayed along the horizontal axis is determined by the duration of each object as determined from the time stamp. The cell borders can also be repositioned as desired by the user as shown in FIG. 59.

The location of files (objects) in the directory can also be controlled by the user with the above directory management method as described below. These methods include moving and locating the objects as desired, and defining and editing the links between objects.

Free Object Placement

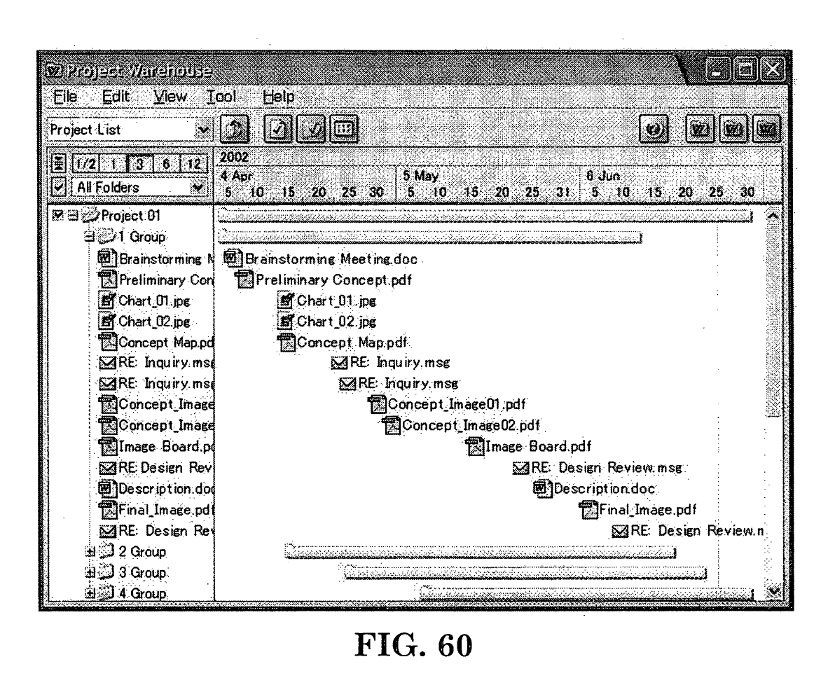

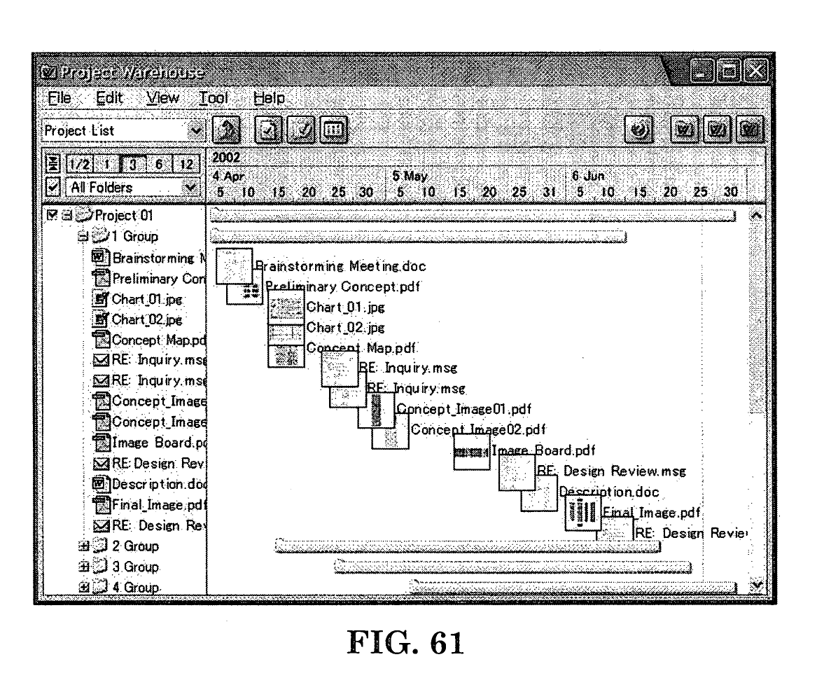

A user interface such as shown in FIG. 60 can be used when one object (file) is displayed per line in chronological order. In this case what application is required can be known from the application icon, but the object content is unknowable. Thumbnail sketches are therefore displayed as shown in FIG. 61 so that object content can also be determined.

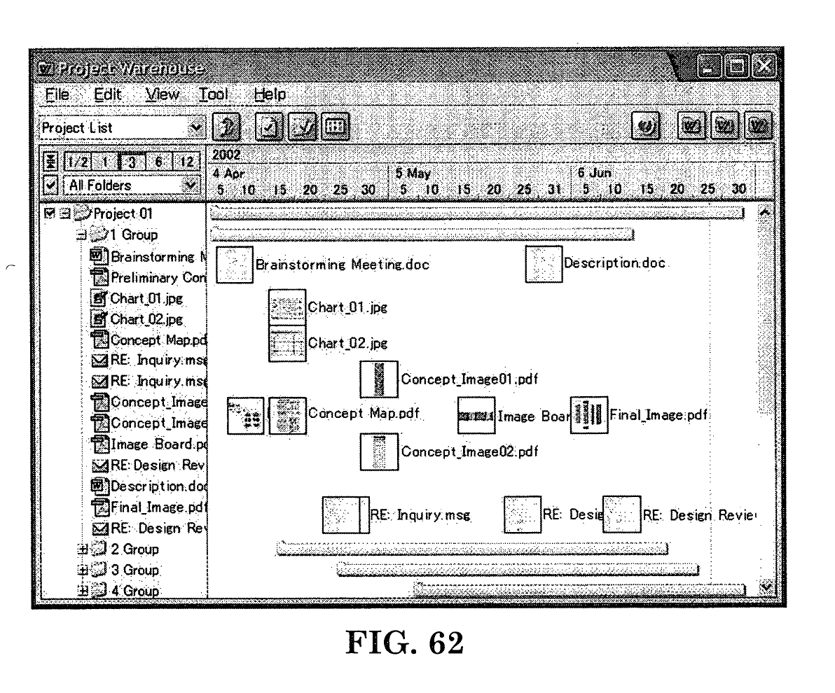

A user interface such as shown in FIG. 62 can then be selected from a menu so that the thumbnail sketches shown in the right pane can be positioned as desired. In this case the directory list shown in the left pane remains in chronological order while the thumbnail sketches shown in the right can be freely moved and positioned according to the progress of the project.

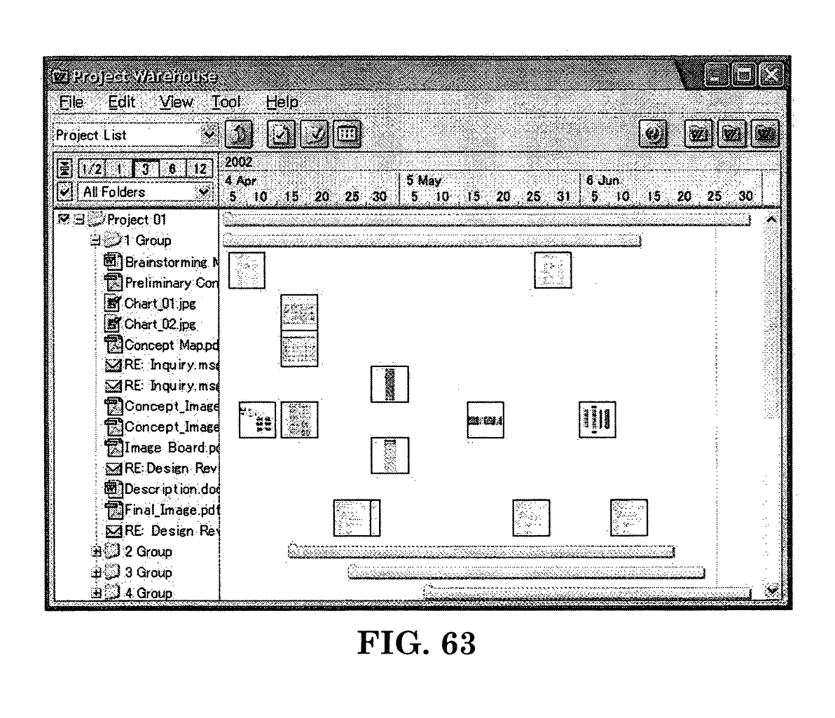

More specifically, when a command to change the display order of the multiple objects associated with each cell of the directory matrix shown in FIG. 62 is received, the server moves and redisplays the objects at the new positions on the file management parameter axis based on the command for changing the display order. If multiple files are displayed on the same line, the display can be made easier to ready by turning the display of file names off as shown in FIG. 63.

Defining and Editing Object Links

The relationship between objects (files) can be expressed using specific attributes such as coloring or arrows. These attributes can also make it easier to visually grasp the progress of a project (branching, integration, references, influences, etc.).

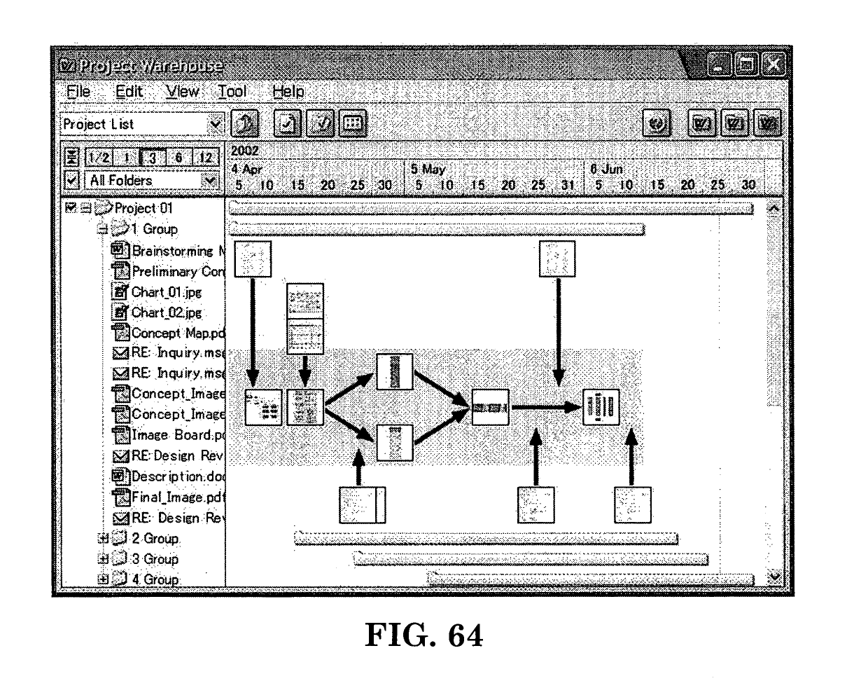

The relationships between objects can be set by the user for each object or group of objects using templates and these relationships can be stored with a specific attribute representing the relationship. Object relationships can then be displayed with an intuitively understandable graphical representation as shown in FIG. 64.

In other words, the correlation between multiple objects associated with individual cells in the directory matrix can be set by the user, and the objects can be displayed with visual attributes representing the relationship between different objects.

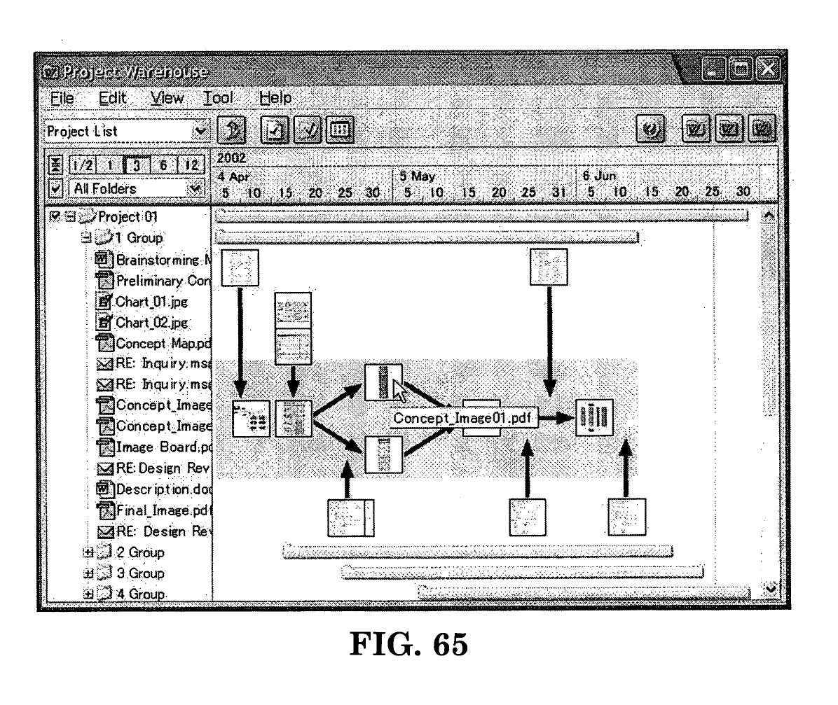

It will also be obvious that the user interface could show other specific attributes of each file (such as the file name, creator, or date) when the pointer is positioned over an object as shown in FIG. 65.

Displaying Action Items and Corresponding Results

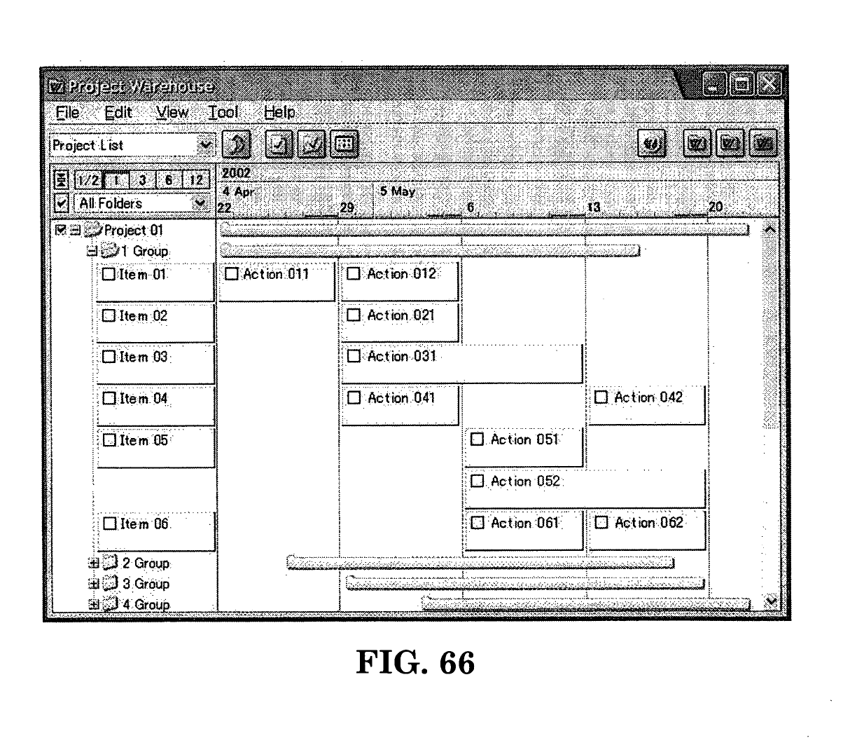

A common and important part of project management is managing action items according to the schedule. In the example shown in FIG. 66 tasks and items for advancing a project are displayed in the left-side directory listing as file management parameters, and corresponding action items are shown in the right pane of the window as a separate file management parameter.

In other words, objects (action items) are displayed linked to a corresponding cell in the directory matrix based on the item settings (the file management parameter on the vertical axis) and the setting of the time line parameter shown on the horizontal axis. This interface enables the user to tell at a glance what must be done this week, for example.

Action items are displayed as planned events and the result of each action item is stored as an object (file). In addition to saving a record of completed events as the project progresses, it is therefore also possible to save specific plans and action items that must be done. It is therefore possible to manage both what must be done (plans) and what has already been done (actual completed events).

In other words, an action item occupying one or more cells of the directory matrix is set up as a project, and the one or more objects linked to the one or plural cells of this action item project are displayed.

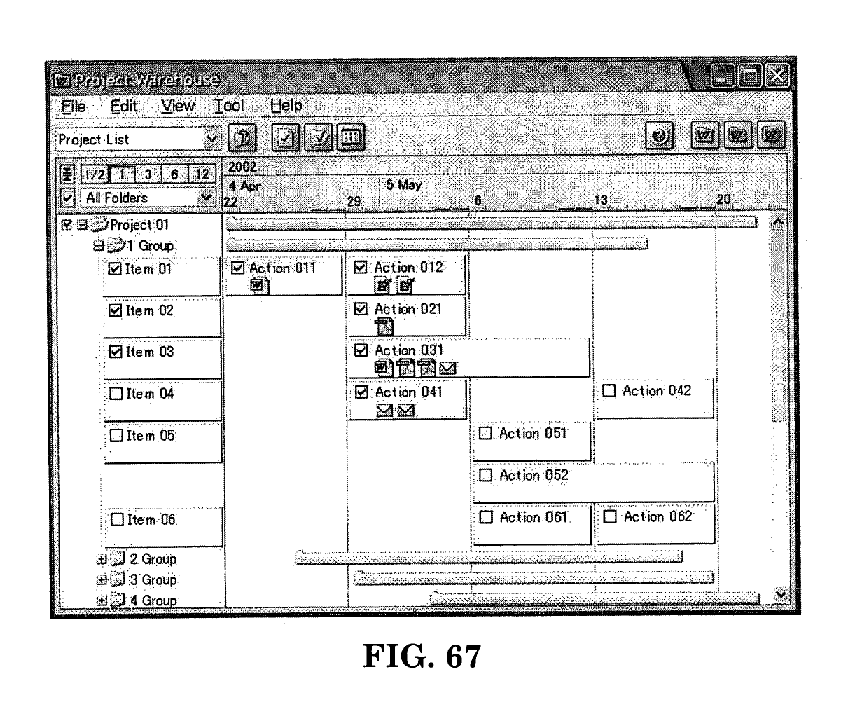

When the icon for a saved file is selected, the content of the file is displayed in a content window. When an action item or task is completed, the user can check the corresponding check box to manage the entire project and individual action items as shown in FIG. 67.

The directory management method of the present invention thus enables more context-rich directory management by using multiple file management parameters at the same time.

The above-described directory management process is executed entirely by a computer system, and can be achieved by a directory management apparatus for running this directory management process. More specifically, a directory management apparatus according to the present invention includes a controller, input part, output part, and directory management processing part.

The controller of this directory management apparatus controls data I/O to the input part, output part, and directory management processor.

The input part is an input interface for accepting data input from the user based on templates for setting object parameters and object links (relationships).

The output part is an output interface for outputting the display data to the display unit or user's client terminal connected via a network. The display data is generated by the directory management processor applying a screen display process to the input data passed from the input part.

Based on the above-described multidimensional parameter settings and object link information, the directory management processor records, updates, and deletes directory management information used at the application level, and based on the result of these actions generates and outputs display data.

More specifically, the directory management apparatus has an internal computer system. The steps in the directory management process are stored as a computer-executable program to a computer-readable data storage medium, and the directory management process is run by the computer reading and executing this program. Yet more specifically, the various processing means and parts of this directory management apparatus are achieved by a CPU or other microprocessor reading and executing the above program stored to ROM, RAM, or other primary storage.

Computer-readable data storage media include magnetic disks, magneto-optical discs, CD-ROM and DVD-ROM discs, and semiconductor memory modules.

The computer program could also be distributed to the computer system via a network or telecommunication line so that the computer receiving the program can run the program.

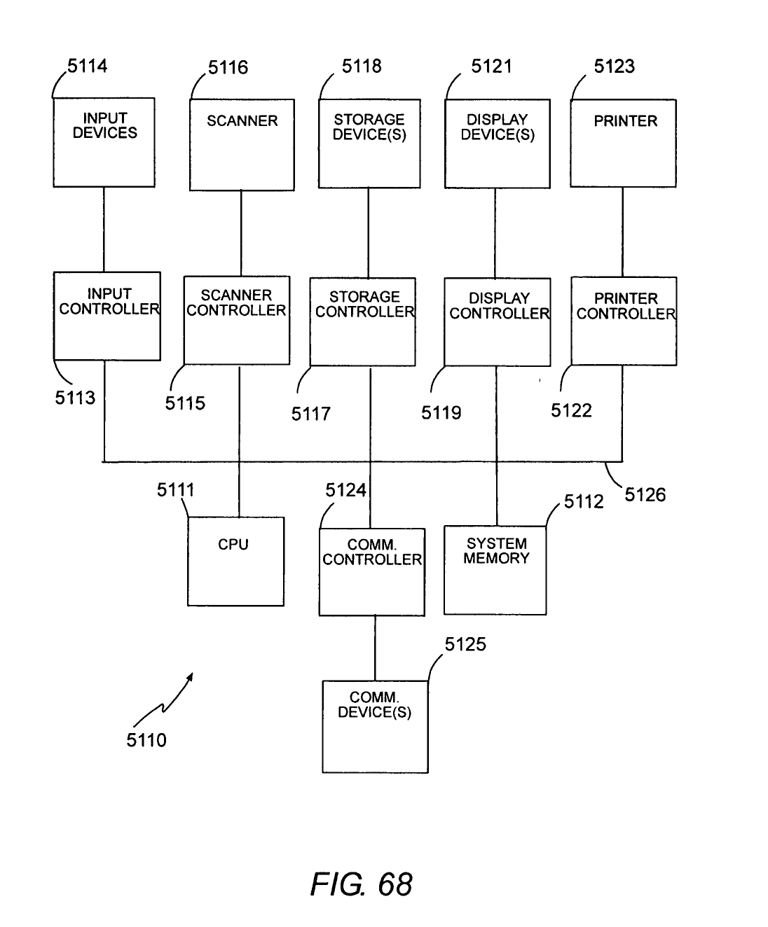

The method/program/processes of the present invention may be conveniently implemented in software that may be run on a processing system 5110 of the type illustrated in FIG. 68. The processing system is described below in the context of a computer or network with peripheral devices including a printer. This is but one example of a processing system in which this invention may be incorporated. This invention may also be embodied in other suitable arrangements.

As illustrated in FIG. 68, the system includes a central processing unit (CPU) 5111 that provides computing resources and controls the system. CPU 5111 may be implemented with a microprocessor or the like, and may also include a graphics processor and/or a floating point coprocessor for mathematical computations. System 5110 further includes system memory 5112 which may be in the form of random-access memory (RAM) and read-only memory (ROM).

Such a system 5110 typically includes a number of controllers and peripheral devices, as shown in FIG. 68. In the illustrated embodiment, input controller 5113 represents an interface to one or more input devices 5114, such as a keyboard, mouse or stylus. There is also a controller 5115 that communicates with a scanner 5116 or equivalent device for digitizing documents. A storage controller 5117 interfaces with one or more storage devices 5118 each of which includes a storage medium such as magnetic tape or disk, or an optical medium that may be used to record programs of instructions for operating systems, utilities and applications which may include embodiments of programs that implement various aspects of the present invention. Storage device(s) 5118 may also be used to store data to be processed/manipulated in accordance with the invention. A display controller 5119 provides an interface to a display device 5121 which may be of any known type.

A printer controller 5122 is also provided for communicating with a printer 5123, which is preferably a laser printer.

A communications controller 5124 interfaces with a communication device 5125 which enables system 5110 to connect to remote devices through any of a variety of networks including the Internet, a local area network (LAN), a wide area network (WAN), or through any suitable electromagnetic carrier signals including infrared signals.

In the illustrated system, all major system components connect to bus 5126 which may represent more than one physical bus.

Depending on the particular application of the invention, various system components may or may not be in physical proximity to one another. For example, the input data and/or the output data may be remotely transmitted from one physical location to another. Also, a program that implements various aspects of the directory management and object display processes may be accessed from a remote location (e.g., a server) over a network. Such data and/or program(s) may be conveyed through any of a variety of machine-readable medium including magnetic tape or disk or optical disc, network signals, or any suitable electromagnetic carrier signal including an infrared signal.

While the present invention may be conveniently implemented with software, a hardware implementation or combined hardware/software implementation is also possible. A hardware implementation may be realized, for example, using ASIC(s), digital signal processing circuitry, or the like. As such, the claim language “machine-readable medium” includes not only software-carrying media, but also hardware having instructions for performing the required processing hardwired thereon, as well as a combination of hardware and software. Similarly, the claim language “program of instructions” includes both software and instructions embedded on hardware. Also, the “means” language used in the claims covers any appropriately configured processing devices, such as instruction-based processors (e.g., CPUs), ASICs, digital processing circuitry, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

It should be noted that this preferred embodiment of the invention has been described running the directory management process at an application level above the operating system, but the directory management process of our invention could be implemented in the operating system or middleware. These implementations are also included in the scope of the present invention.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A machine-readable medium having a program of instructions for directing a machine to execute an object display program, the object display program comprising:
a process for setting the values of multidimensional parameters for a specific object; and
a process for displaying the object linked to a particular cell of a directory matrix defined by the multidimensional parameters based on the multidimensional parameter settings of the object.

2. A machine-readable medium as described in claim 1, the object display program further comprising:
a process for storing multiple objects linked to a particular cell of the directory matrix; and
a process for displaying multiple linked objects as a single icon.

3. A machine-readable medium having a program of instructions for directing a machine to execute a directory management program, the directory management program comprising:
a process for setting the values of multidimensional parameters for a specific object; and
a process for linking the object to a particular cell of a directory matrix defined by the multidimensional parameters based on the multidimensional parameter settings of the object.

4. A machine-readable medium as described in claim 3, the directory management program further comprising:
a process for storing multiple objects linked to a particular cell of the directory matrix.

5. A machine-readable medium as described in claim 3, the directory management program further comprising:
a process for defining a correlation between multiple objects associated with a particular cell of the directory matrix.

6. A machine-readable medium as described in claim 5, the directory management program further comprising:
a process for creating a project comprising one or multiple cells of the directory matrix; and
a process for displaying the objects linked to the one or multiple cells of the project.

7. An object display apparatus comprising:
means for setting the values of multidimensional parameters for an specific object;
means for displaying the object linked to a particular cell of an directory matrix defined by the multidimensional parameters based on the multidimensional parameter settings of the object;
means for storing multiple objects linked to a particular cell of the directory matrix; and
means for displaying multiple linked objects as a group icon by connecting each icon of the objects by using a visual link to join icons into a group icon;
means for receiving an open command for the multiple objects displayed as a group icon; and
means for opening and displaying the multiple objects based on the open command, wherein each of the multiple objects are opened and displayed by a respective application that created the object.

8. An object display method comprising:
setting the values of multidimensional parameters for an specific object;
displaying the object linked to a particular cell of an directory matrix defined by the multidimensional parameters based on the multidimensional parameter settings of the object;
storing multiple objects linked to a particular cell of the directory matrix; and
displaying multiple linked objects as a group icon by connecting each icon of the objects by using a visual link to join icons into a group icon;
receiving an open command for the multiple objects displayed as a group icon; and
opening and displaying the multiple objects based on the open command, wherein each of the multiple objects are opened and displayed by a respective application that created the object.

9. A directory management apparatus comprising:
means for setting the values of multidimensional parameters for a specific object;
means for linking the object to a particular cell of a directory matrix defined by the multidimensional parameters based on the multidimensional parameter settings of the object; and
means for a user to define a relationship between multiple objects associated with a particular cell of the directory matrix, wherein the means for defining a relationship between multiple objects includes means for displaying a visual expression of the relationship using specific attributes.

10. A directory management method comprising:
setting the values of multidimensional parameters for a specific object;
linking the object to a particular cell of a directory matrix defined by the multidimensional parameters based on the multidimensional parameter settings of the object; and
defining, by a user, a relationship between multiple objects associated with a particular cell of the directory matrix, wherein the defining a relationship between multiple objects includes displaying a visual expression of the relationship using specific attributes.
